(19) United States
(12) Patent Application Publication
(10) Pub. No.: US 2023/0362969 A1
(43) Pub. Date: Nov. 9, 2023

(54) USER EQUIPMENT SUBBAND FILTERING

(71) Applicant: QUALCOMM Incorporated, San Diego, CA (US)

(72) Inventors: Muhammad Sayed Khairy ABDELGHAFFAR, San Jose, CA (US); Abdelrahman Mohamed Ahmed Mohamed IBRAHIM, San Diego, CA (US); Ahmed Attia ABOTABL, San Diego, CA (US); Krishna Kiran MUKKAVILLI, San Diego, CA (US)

(21) Appl. No.: 17/662,390

(22) Filed: May 6, 2022

(51) Int. Cl. H04W 72/08; H04L 5/00; H04L 5/14

(52) U.S. Cl. CPC H04W 72/082; H04L 5/001; H04L 5/14

(57) ABSTRACT

Various aspects of the present disclosure generally relate to wireless communication. In some aspects, a user equipment (UE) may transmit, to a network entity, an indication that the UE supports downlink subband filtering within a bandwidth of a component carrier (CC) associated with the UE. The UE may receive, from the network entity and based on transmitting the indication, a downlink signal within a downlink subband that is included in the bandwidth of the CC based on filtering out signals within the bandwidth of the CC that are associated with frequency domain resources not included within the downlink subband. Numerous other aspects are provided.

### FIELD OF THE DISCLOSURE

Aspects of the present disclosure generally relate to wireless communication and specifically, to techniques and apparatuses for enabling user equipment (UE) subband filtering.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In some cases, a wireless communication device (such as a user equipment (UE) or a network entity) may support full-duplex operations. Full-duplex operations may include the wireless communication device transmitting and receiving at approximately the same time. For example, full-duplex operations may include a subband full-duplex (SBFD) mode. The SBFD mode may also be referred to as a subband frequency division duplex mode or a flexible duplex mode. In the SBFD mode, the wireless communication device may transmit and receive at a same time, but the wireless communication device may transmit and receive on different frequency domain resources. In some cases, a slot configuration may include a combination of downlink slots, uplink slots, or SBFD slots. An SBFD slot may include one or more downlink time/frequency resources and one or more uplink time/frequency resources. For example, a UE may receive a downlink signal in an SBFD slot. Within a bandwidth of a carrier (for example, a component carrier (CC) bandwidth or a channel bandwidth) or a bandwidth of a bandwidth part (BWP), the SBFD slot may include time/frequency resources allocated for uplink transmissions (for example, uplink transmissions by the UE or by another UE). A downlink time/frequency resource in the SBFD slot may be separated (for example, in time or frequency) from an uplink time/frequency resource in the SBFD slot by a gap, which may function to reduce self-interference and improve latency and uplink coverage.

A filter (for example, a bandpass filter, a radio frequency (RF) filter, a digital filter, or another filter) may be associated with isolating signals within a given frequency range and filtering out signals that are outside of the given frequency range. Typically, a wideband filter may be used by a UE to receive a downlink signal. For example, a filter may isolate radio signals from different spectrum bands to enable the UE to receive the signals. A wideband filter may isolate signals of a carrier or BWP and may filter out signals associated with frequency domain resources outside of the bandwidth of the carrier or BWP.

In some cases, despite the use of a gap, SBFD operations may still introduce the potential for interference to be experienced by a UE. For example, in an SBFD slot, the bandwidth of a carrier or CC may be associated with both uplink signals and downlink signals. For example, a network entity operating in an SBFD mode may schedule a first UE to receive a downlink signal in an SBFD slot and in a bandwidth of a CC, and may schedule a second UE to transmit an uplink signal in the SBFD slot and in the bandwidth of the CC. The first UE may filter the bandwidth associated with the carrier or BWP to isolate signals within the bandwidth and filter out signals outside of the bandwidth. However, this may result in the first UE isolating both the downlink signal and one or more uplink signals (for example, the uplink signal that is transmitted by the second UE). The one or more uplink signals may cause interference associated with the downlink signal. The interference may bias an automatic gain control (AGC) of the UE or block the RF front end. The interference may also result in increased noise experienced by the UE (for example, because the UE may operate at a higher gain state). Additionally, the interference may reduce a dynamic range of the intended downlink signal. As another example, the interference may reduce a signal-to-interference-plus-noise ratio (SINK) of the intended downlink signal. In some examples, where the interference is high, an RF front end (RFFE) of the UE may become saturated (for example, may be blocked) and the UE may be unable to receive the intended downlink signal. Therefore, the interference associated with SBFD may result in degraded downlink performance for the UE.

### SUMMARY

Some aspects described herein relate to a user equipment (UE) for wireless communication. The UE may include at least one memory and at least one processor communicatively coupled with the at least one memory. The at least one processor may be configured to cause the UE to transmit, to a network entity, an indication that the UE supports downlink subband filtering within a bandwidth of a component carrier (CC) associated with the UE. The at least one processor may be configured to cause the UE to receive, from the network entity and based on transmitting the indication, a downlink signal within a downlink subband that is included in the bandwidth of the CC based on filtering out signals within the bandwidth of the CC that are associated with frequency domain resources not included within the downlink subband.

Some aspects described herein relate to a network entity for wireless communication. The network entity may include at least one memory and at least one processor communicatively coupled with the at least one memory. The at least one processor may be configured to cause the network entity to receive an indication that a UE supports downlink subband filtering within a bandwidth of a CC associated with the UE. The at least one processor may be configured to cause the network entity to transmit, based on receiving the indication, a communication scheduling a downlink signal for the UE associated with the CC in a slot associated with full-duplex operations.

Some aspects described herein relate to a method of wireless communication performed by a UE. The method may include transmitting, to a network entity, an indication that the UE supports downlink subband filtering within a bandwidth of a CC associated with the UE. The method may include receiving, from the network entity and based on transmitting the indication, a downlink signal within a downlink subband that is included in the bandwidth of the CC based on filtering out signals within the bandwidth of the CC that are associated with frequency domain resources not included within the downlink subband.

Some aspects described herein relate to a method of wireless communication performed by a network entity. The method may include receiving an indication that a UE supports downlink subband filtering within a bandwidth of a CC associated with the UE. The method may include transmitting, based on receiving the indication, a communication scheduling a downlink signal for the UE associated with the CC in a slot associated with full-duplex operations.

Some aspects described herein relate to a non-transitory computer-readable medium that stores a set of instructions for wireless communication by a UE. The set of instructions, when executed by one or more processors of the UE, may cause the UE to transmit, to a network entity, an indication that the UE supports downlink subband filtering within a bandwidth of a CC associated with the UE. The set of instructions, when executed by one or more processors of the UE, may cause the UE to receive, from the network entity and based on transmitting the indication, a downlink signal within a downlink subband that is included in the bandwidth of the CC based on filtering out signals within the bandwidth of the CC that are associated with frequency domain resources not included within the downlink subband.

Some aspects described herein relate to a non-transitory computer-readable medium that stores a set of instructions for wireless communication by a network entity. The set of instructions, when executed by one or more processors of the network entity, may cause the network entity to receive an indication that a UE supports downlink subband filtering within a bandwidth of a CC associated with the UE. The set of instructions, when executed by one or more processors of the network entity, may cause the network entity to transmit, based on receiving the indication, a communication scheduling a downlink signal for the UE associated with the CC in a slot associated with full-duplex operations.

Some aspects described herein relate to an apparatus for wireless communication. The apparatus may include means for transmitting, to a network entity, an indication that the apparatus supports downlink subband filtering within a bandwidth of a CC associated with the apparatus. The apparatus may include means for receiving, from the network entity and based on transmitting the indication, a downlink signal within a downlink subband that is included in the bandwidth of the CC based on filtering out signals within the bandwidth of the CC that are associated with frequency domain resources not included within the downlink subband.

Some aspects described herein relate to an apparatus for wireless communication. The apparatus may include means for receiving an indication that a UE supports downlink subband filtering within a bandwidth of a CC associated with the UE. The apparatus may include means for transmitting, based on receiving the indication, a communication scheduling a downlink signal for the UE associated with the CC in a slot associated with full-duplex operations.

Aspects generally include a method, apparatus, system, computer program product, non-transitory computer-readable medium, user equipment, base station, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example base station in communication with a user equipment (UE) in a wireless network in accordance with the present disclosure.

FIG. 3 is a diagram illustrating an example disaggregated base station architecture, in accordance with the present disclosure.

FIGS. 4A-4C are diagrams illustrating examples of full-duplex (FD) communication, in accordance with the present disclosure.

FIG. 5 is a diagram illustrating an example of FD communication modes, in accordance with the present disclosure.

FIG. 6 is a diagram illustrating examples of FD communication, in accordance with the present disclosure.

FIG. 7 is a diagram illustrating an example of a subband FD (SBFD) slot, in accordance with the present disclosure.

FIG. 8 is a diagram of an example associated with UE subband filtering, in accordance with the present disclosure.

FIG. 9 is a diagram of an example associated with downlink subbands within a bandwidth of a component carrier (CC), in accordance with the present disclosure.

FIG. 10 is a diagram of an example associated with parameters associated with downlink subband filtering, in accordance with the present disclosure.

FIG. 11 is a flowchart illustrating an example process performed, for example, by a UE, associated with UE subband filtering, in accordance with the present disclosure.

FIG. 12 is a flowchart illustrating an example process performed, for example, by a network entity, associated with UE subband filtering, in accordance with the present disclosure.

FIG. 13 is a diagram of an example apparatus for wireless communication in accordance with the present disclosure.

FIG. 14 is a diagram of an example apparatus for wireless communication in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to user equipment (UE) subband filtering within a channel, such as within a component carrier (CC). Some aspects more specifically relate to a UE selectively receiving a downlink signal, based on performing downlink subband filtering, in the presence of an interfering signal in the same CC) bandwidth (which may also be referred to as a channel bandwidth). For example, the UE may receive a downlink signal within a downlink subband that is included in a bandwidth of a CC based on filtering out signals within the bandwidth of the CC that are associated with frequency domain resources not included within the downlink subband. As an example, the UE may receive the downlink signal in a subband full-duplex (SBFD) slot. An SBFD slot may include time-frequency resources associated with downlink signals and time-frequency resources associated with uplink signals (for example, in the same CC bandwidth). The UE may filter out signals, transmitted by other devices in the SBFD slot, that are associated with frequency domain resources not included within a downlink subband of the SBFD slot.

In some aspects, the UE may transmit an indication that the UE supports downlink subband filtering within the bandwidth of the CC associated with the UE. For example, the UE may transmit, to a network entity, indications of: a quantity of downlink subbands, within the CC, that are supported by the UE; whether a single downlink subband or multiple downlink subbands within the CC are supported by the UE; a first supported quantity (for example, a maximum or otherwise upper bound) of frequency domain resources between any subbands within the CC; a second supported quantity (for example, a minimum or otherwise lower bound) of frequency domain resources between any subbands within the CC; a bandwidth of each subband associated with the CC; or a third supported quantity of frequency domain resources between an uplink subband and the downlink subband to enable the UE to filter out signals included in the uplink subband when receiving signals included in the downlink subband, among other examples. Based at least in part on receiving the indication that the UE supports downlink subband filtering within the bandwidth of the CC associated with the UE, the network entity may schedule one or more downlink communications for the UE in a slot associated with full-duplex operations (such as an SBFD slot).

Particular aspects of the subject matter described in this disclosure can be implemented to realize one or more of the following potential advantages. In some examples, the described techniques can be used to reduce interference caused by signals received by a UE in a bandwidth of a CC that are not associated with a downlink signal intended for the UE (for example, uplink signals transmitted by one or more other UEs using frequency domain resources that are included in the bandwidth of the CC and at a time that at least partially overlaps with time domain resources of the downlink signal). Additionally, the transmission, by a UE, of an indication of a capability associated with performing downlink subband filtering may enable a network entity to make improved scheduling decisions. For example, if a UE indicates that the UE is capable of performing downlink subband filtering, then the network entity may schedule the UE to receive a downlink communication in a slot associated with full-duplex operations (such as a subband full-duplex (SBFD) slot) to improve resource utilization or to reduce latency (for example, because the UE is capable of mitigating negative effects caused by interfering signals transmitted by other devices in the slot associated with full-duplex operations by performing downlink subband filtering, as explained in more detail elsewhere herein). As another example, if a UE indicates that the UE is not capable of performing downlink subband filtering, then the network entity may schedule the UE to receive a downlink communication in a slot that is not associated with full-duplex operations (for example, full-duplex operations performed by the network entity) to reduce a likelihood of the UE experiencing interference caused by uplink transmissions from other UEs in the same slot that the UE is receiving a downlink communication.

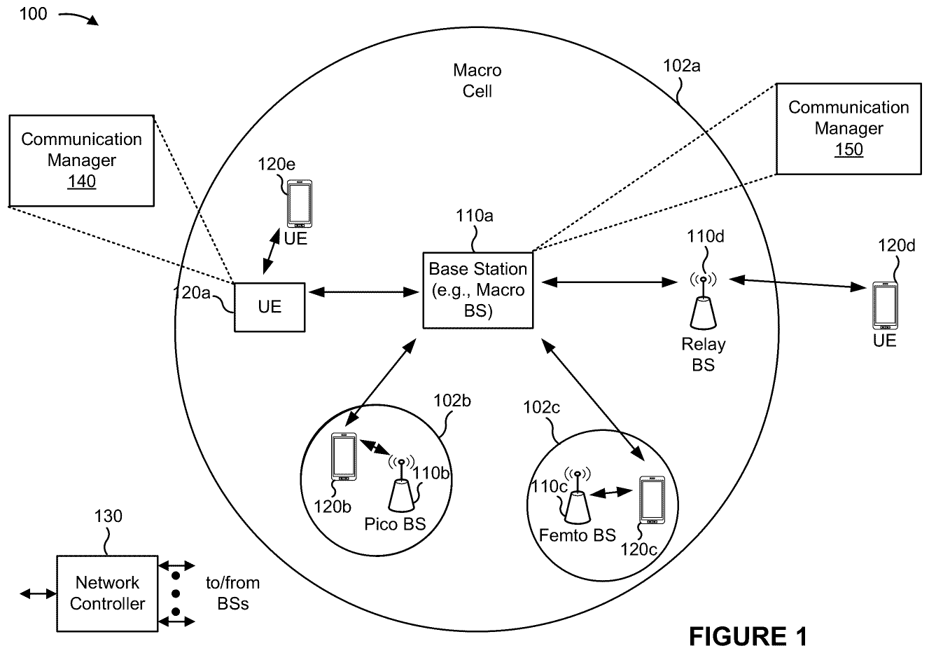

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), or other network entities. A base station 110 is an entity that communicates with UEs 120. A base station 110 (sometimes referred to as a BS) may include, for example, an NR base station, an LTE base station, a Node B, an eNB (for example, in 4G), a gNB (for example, in 5G), an access point, or a transmission reception point (TRP). Each base station 110 may provide communication coverage for a particular geographic area. In the Third Generation Partnership Project (3GPP), the term “cell” can refer to a coverage area of a base station 110 or a base station subsystem serving this coverage area, depending on the context in which the term is used.

A base station 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station.

The wireless network 100 may be a heterogeneous network that includes base stations 110 of different types, such as macro base stations, pico base stations, femto base stations, or relay base stations. These different types of base stations 110 may have different transmit power levels, different coverage areas, or different impacts on interference in the wireless network 100. For example, macro base stations may have a high transmit power level (for example, 5 to 40 watts) whereas pico base stations, femto base stations, and relay base stations may have lower transmit power levels (for example, 0.1 to 2 watts). In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (for example, three) cells. A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

In some aspects, the term “base station” (for example, the base station 110) or “network entity” may refer to an aggregated base station, a disaggregated base station, an integrated access and backhaul (IAB) node, a relay node, or one or more components thereof. For example, in some aspects, “base station” or “network entity” may refer to a central unit (CU), a distributed unit (DU), a radio unit (RU), a Near-Real Time (Near-RT) RAN Intelligent Controller (MC), or a Non-Real Time (Non-RT) MC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move in accordance with the location of a base station 110 that is mobile (for example, a mobile base station). In some examples, the base stations 110 may be interconnected to one another or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a base station 110 or a UE 120) and send a transmission of the data to a downstream station (for example, a UE 120 or a base station 110). A relay station may be a UE 120 that can relay transmissions for other UEs 120. In the example shown in FIG. 1, the BS 110d (for example, a relay base station) may communicate with the BS 110a (for example, a macro base station) and the UE 120d in order to facilitate communication between the BS 110a and the UE 120d. A base station 110 that relays communications may be referred to as a relay station, a relay base station, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the base station 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz,” if used herein, may broadly represent frequencies that may be less than 6 GHz, may be within FR1, or may include mid-band frequencies. Further, unless specifically stated otherwise, it should be understood that the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may transmit, to a network entity, an indication that the UE supports downlink subband filtering within a bandwidth of a CC associated with the UE; and receive, from the network entity and based on transmitting the indication, a downlink signal within a downlink subband that is included in the bandwidth of the CC based on filtering out signals within the bandwidth of the CC that are associated with frequency domain resources not included within the downlink subband. Additionally or alternatively, the communication manager 140 may perform one or more other operations described herein.

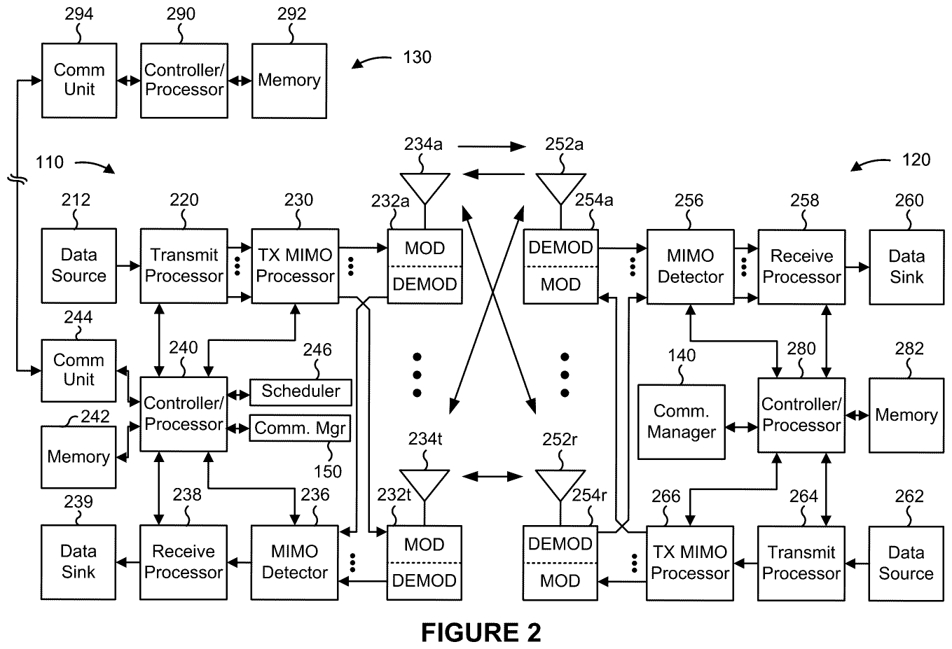

In some aspects, a network entity (shown in FIGS. 1 and 2 as a base station 110 as an example) may include a communication manager 150. As described in more detail elsewhere herein, the communication manager 150 may receive an indication that a UE supports downlink subband filtering within a bandwidth of a CC associated with the UE; and transmit, based on receiving the indication, a communication scheduling a downlink signal for the UE associated with the CC in a slot associated with full-duplex operations. Additionally or alternatively, the communication manager 150 may perform one or more other operations described herein.

FIG. 2 is a diagram illustrating an example base station 110 in communication with a UE 120 in a wireless network in accordance with the present disclosure. The base station 110 may correspond to the base station 110 of FIG. 1. Similarly, the UE 120 may correspond to the UE 120 of FIG. 1. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the base station 110 or other base stations 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the base station 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

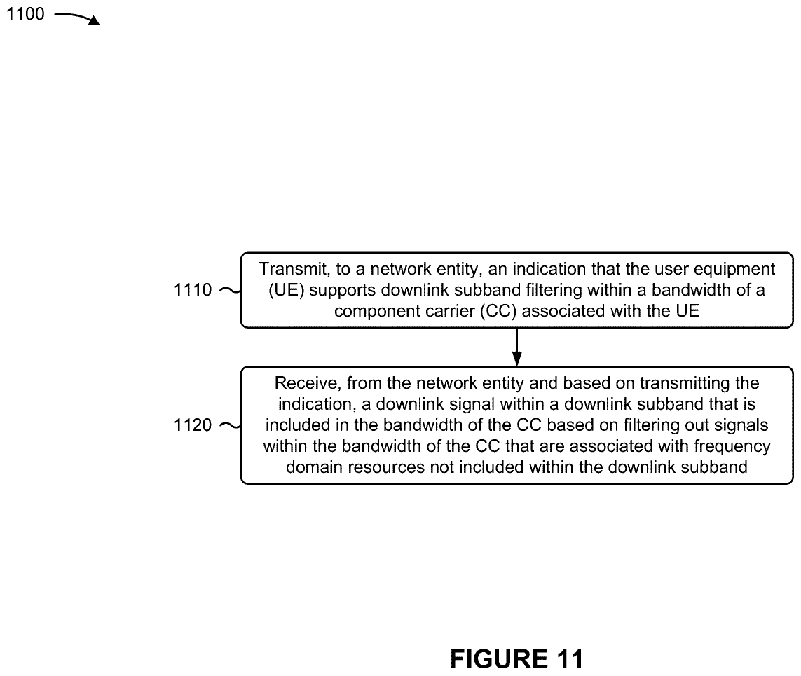

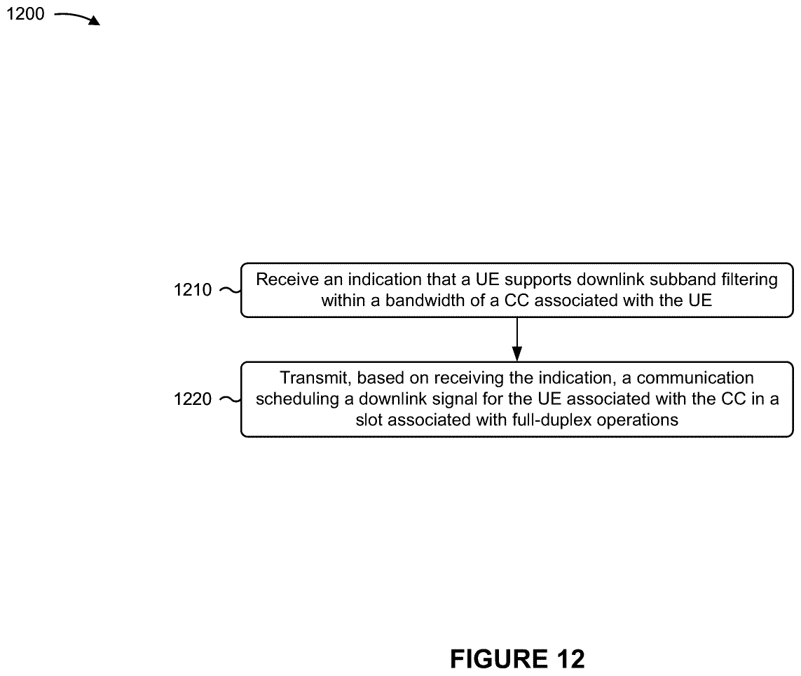

The controller/processor 240 of the base station 110, the controller/processor 280 of the UE 120, or any other component(s) of FIG. 2 may perform one or more techniques associated with UE subband filtering, as described in more detail elsewhere herein. For example, the controller/processor 240 of the base station 110, the controller/processor 280 of the UE 120, or any other component(s) of FIG. 2 may perform or direct operations of, for example, process 1100 of FIG. 11, process 1200 of FIG. 12, or other processes as described herein. The memory 242 and the memory 282 may store data and program codes for the base station 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the base station 110 or the UE 120, may cause the one or more processors, the UE 120, or the base station 110 to perform or direct operations of, for example, process 1100 of FIG. 11, process 1200 of FIG. 12, or other processes as described herein. In some examples, executing instructions may include running the instructions, converting the instructions, compiling the instructions, or interpreting the instructions, among other examples.

In some aspects, the UE 120 includes means for transmitting, to a network entity, an indication that the UE 120 supports downlink subband filtering within a bandwidth of a CC associated with the UE 120; or means for receiving, from the network entity and based on transmitting the indication, a downlink signal within a downlink subband that is included in the bandwidth of the CC based on filtering out signals within the bandwidth of the CC that are associated with frequency domain resources not included within the downlink subband. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity includes means for receiving an indication that a UE supports downlink subband filtering within a bandwidth of a CC associated with the UE; or means for transmitting, based on receiving the indication, a communication scheduling a downlink signal for the UE associated with the CC in a slot associated with full-duplex operations. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station.

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as a central unit (CU), one or more distributed units (DUs), or one or more radio units (RUs)). In some examples, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

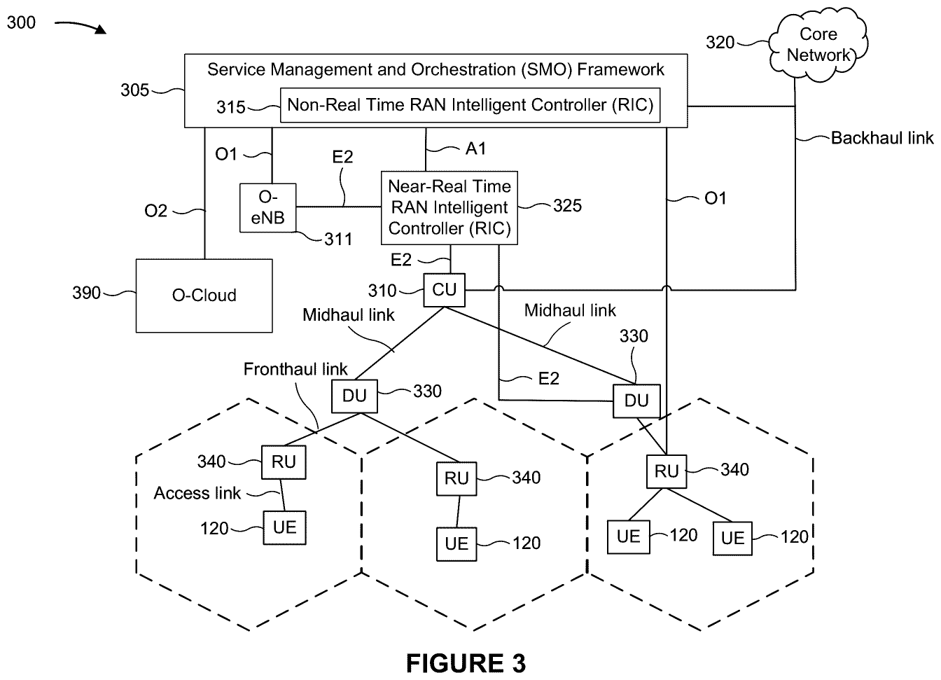

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which may also be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based at least in part on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

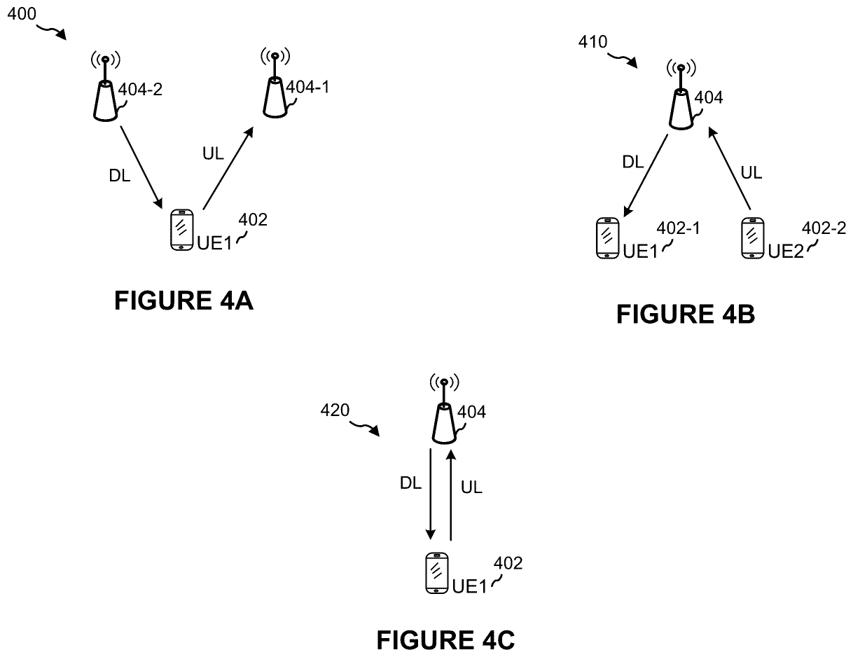

FIGS. 4A-4C are diagrams illustrating examples of full-duplex (FD) communication in accordance with the present disclosure. A first full-duplex scenario 400 depicted in FIG. 4A includes a UE1 402 and two base stations (for example, network entities or TRPs) 404-1, 404-2, where the UE1 402 is sending uplink transmissions to base station 404-1 and is receiving downlink transmissions from base station 404-2. In the first full-duplex scenario 400 of FIG. 4A, FD is enabled for the UE1 402, but not for the base stations 404-1, 404-2. A second full-duplex scenario 410 depicted in FIG. 4B includes two UEs, shown as UE1 402-1 and UE2 402-2, and a base station 404, where the UE1 402-1 is receiving a downlink transmission from the base station 404 and the UE2 402-2 is transmitting an uplink transmission to the base station 404. In the second full-duplex scenario 410, FD is enabled for the base station 404, but not for UE1 402-1 and UE2 402-2. A third full-duplex scenario 420 is depicted in FIG. 4C that includes a UE1 402 and a base station 404, where the UE1 402 is receiving a downlink transmission from the base station 404 and the UE1 402 is transmitting an uplink transmission to the base station 404. In the third full-duplex scenario 420, FD is enabled for both the UE1 402 and the base station 404.

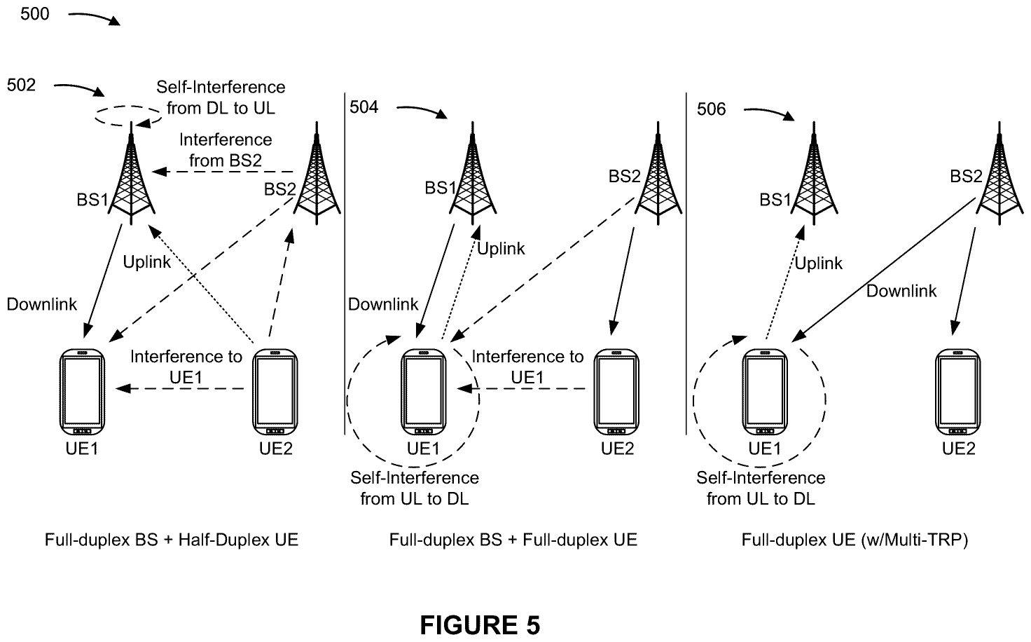

FIG. 5 is a diagram illustrating an example of full-duplex communication modes 500, in accordance with the present disclosure. In a first mode 502, a first network entity (shown as BS1) and a second network entity (shown as BS2) may be full-duplex devices (for example, may be capable of communicating in a full-duplex manner). A first UE and a second UE may be half duplex UEs (for example, may not be capable of communicating in a full-duplex manner). The first network entity may perform downlink transmissions to the first UE, and the first network entity on may receive uplink transmissions from the second UE. The first network entity may experience self-interference from a downlink to an uplink based at least in part on the downlink transmissions to the first UE and the uplink transmissions received from the second UE. The first network entity may experience interference from the second network entity. The first UE may experience interference from the second network entity and the second UE.

In a second mode 504, a first network entity and a second network entity may be full-duplex devices. A first UE and a second UE may be full-duplex UEs. The first network entity may perform downlink transmissions to the first UE, and the first network entity may receive uplink transmissions from the first UE. The first UE may experience self-interference from an uplink to a downlink based at least in part on the downlink transmissions from the first network entity and the uplink transmissions to the first network entity. The first UE may experience interference from the second network entity and the second UE.

In a third mode 506, a first UE and a second UE may be full-duplex UEs and may communicate in a multi-TRP configuration. A first network entity may receive uplink transmissions from the first UE, and a second network entity may perform downlink transmissions to the first UE and the second UE. The first UE may experience self-interference from an uplink to a downlink based at least in part on the uplink transmissions to the first network entity and the downlink transmissions from the second network entity.

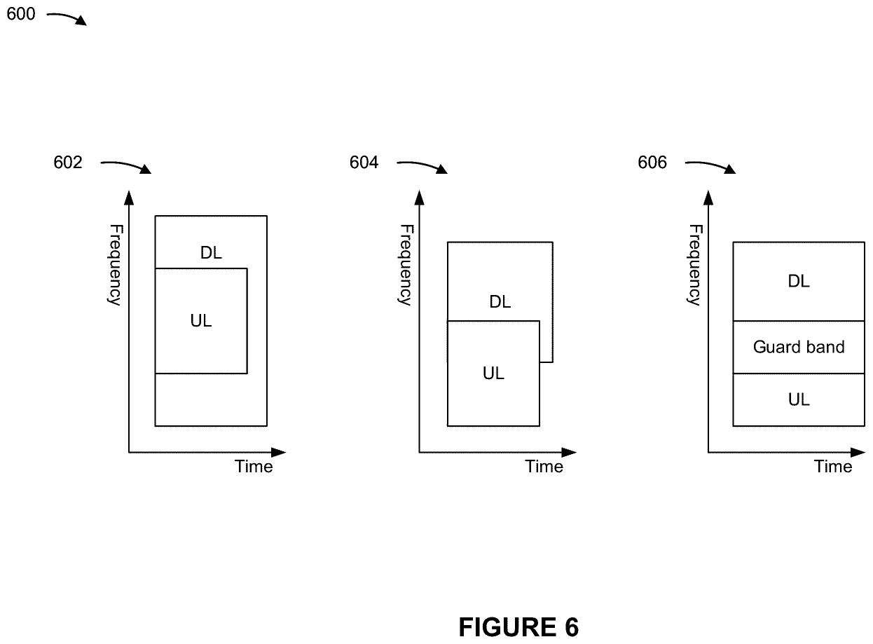

FIG. 6 is a diagram illustrating examples of full-duplex communication 600, in accordance with the present disclosure. A UE may operate in an in-band full-duplex mode. In the in-band full-duplex mode, the UE may transmit and receive on a same time and frequency resource. An uplink and a downlink may share the same time and frequency resource. For example, in a first full-duplex communication 602, a time and frequency resource for the uplink may fully overlap with a time and frequency resource for the downlink. As another example, in a second full-duplex communication 604, a time and frequency resource for the uplink may partially overlap with a time and frequency resource for the downlink.

A UE may operate in a subband full-duplex (SBFD) mode. The SBFD mode may also be referred to as a subband frequency division duplex mode or a flexible duplex mode. In the SBFD mode, the UE may transmit and receive at a same time, but the UE may transmit and receive on different frequency domain resources. For example, in a third full-duplex communication 606, a downlink resource may be separated from an uplink resource by a guard band in a frequency domain. In some examples, SBFD may be associated with a network entity that is operating in a full-duplex mode (for example, transmitting and receiving at the same time on different frequency domain resources). In such examples, UEs communicating with the network entity may be operating in a half-duplex mode.

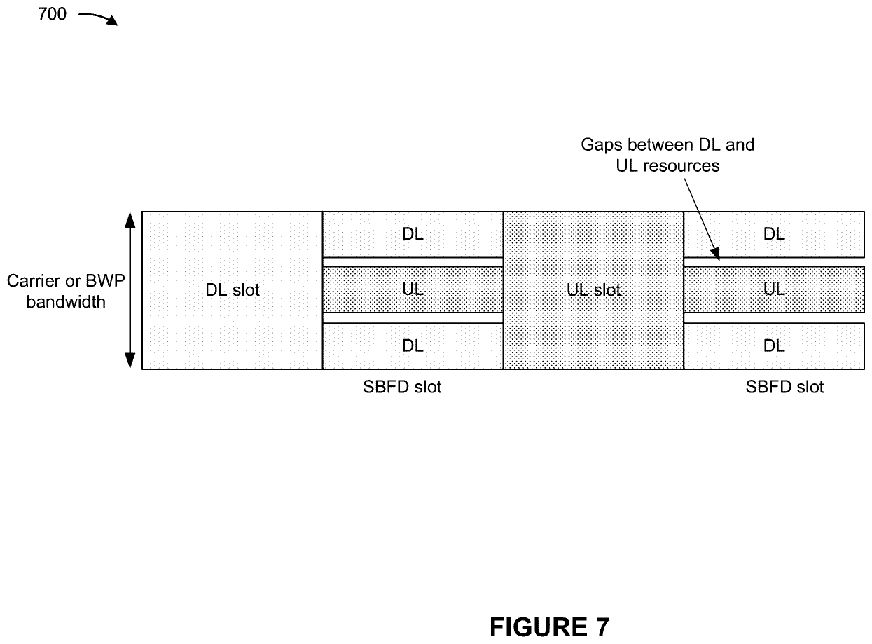

FIG. 7 is a diagram illustrating an example of an SBFD slot 700, in accordance with the present disclosure. As shown in FIG. 7, a slot configuration may include a combination of downlink slots, uplink slots, or SBFD slots. An SBFD slot may include one or more downlink time/frequency resources and one or more uplink time/frequency resources. A downlink time/frequency resource in the SBFD slot may be separated (for example, in time or frequency) from an uplink time/frequency resource in the SBFD slot by a gap, which may function to reduce self-interference and improve latency and uplink coverage. For example, the gap may be a frequency offset or a frequency gap between downlink time/frequency resources and uplink time/frequency resources in the same SBFD slot. For example, a network entity may be operating in a SBFD mode (for example, transmitting and receiving at the same time on different frequency domain resources). The network entity may schedule a first UE to receive a downlink communication in an SBFD slot. The network entity may schedule a second UE to transmit an uplink communication in the same SBFD slot. As explained elsewhere herein, the uplink communication may cause interference for the first UE that is receiving the downlink communication.

As described elsewhere herein, SBFD operations may introduce the potential for interference to be experienced by a UE. For example, a UE may receive a downlink signal in an SBFD slot. Within a bandwidth of a carrier (or component carrier (CC)) or a bandwidth part, the SBFD slot may include time/frequency resources allocated for uplink transmissions (for example, by the UE or by other UEs). In some cases, a filter used to receive a signal by a UE may be a wideband filter. A filter (for example, a bandpass filter, an RF filter, or another filter) may be associated with isolating signals within a given frequency range and filtering out signals that are outside of the given frequency range. For example, a filter may isolate radio signals from different spectrum bands to enable the UE to receive the signals. A wideband filter may be associated with isolating signals within a bandwidth of a given carrier, CC, or BWP. For example, a wideband filter may isolate signals of the carrier or CC shown in FIG. 7 and may filter out signals associated with frequency domain resources outside of the bandwidth of the carrier or CC. In other words, wideband filtering may isolate signals within a given band (for example, within the bandwidth of a CC). However, as shown in FIG. 7, in an SBFD slot, the bandwidth of a carrier or CC may be associated with both uplink signals and downlink signals. Therefore, a UE may filter the bandwidth associated with the carrier or CC to isolate signals within the bandwidth and filter out signals outside of the bandwidth. However, this may result in the UE isolating both an intended downlink signal (for example, a downlink signal intended for the UE) and one or more uplink signals (for example, uplink signals that are not intended for the UE, such as those transmitted by another UE intended for a network entity). The one or more uplink signals may cause interference associated with the intended downlink signal. The interference may bias an automatic gain control (AGC) of the UE. The interference may also result in increased noise experienced by the UE (for example, because the UE may operate at a higher gain state). Additionally, the interference may reduce a dynamic range of the intended downlink signal. As another example, the interference may reduce a signal-to-interference-plus-noise ratio (SINR) of the intended downlink signal. In some examples, where the interference is high, an RF front end (RFFE) of the UE may become saturated (for example, may be blocked) and the UE may be unable to receive the intended downlink signal. Therefore, the interference associated with SBFD may result in degraded downlink performance for the UE.

Various aspects relate generally to UE subband filtering. Some aspects more specifically relate to in-channel selectivity related to a UE selectively receiving a downlink signal in the presence of an interfering signal in the same CC. For example, the UE may receive a downlink signal within a downlink subband that is included in a bandwidth of a CC based on filtering out signals within the bandwidth of the CC that are associated with frequency domain resources not included within the downlink subband. In other words, the UE may selectively receive a downlink signal in a downlink subband of a CC in the presence of other signals within the same CC.

In some aspects, the UE may transmit an indication that the UE supports downlink subband filtering within the bandwidth of the CC associated with the UE. For example, the UE may transmit, to a network entity, indications of: a quantity of downlink subbands, within the CC, that are supported by the UE; whether a single downlink subband or multiple downlink subbands within the CC are supported by the UE; a first supported quantity of frequency domain resources between any subbands within the CC; a second supported quantity of frequency domain resources between subbands within the CC; a bandwidth of each subband associated with the CC; or a third supported quantity of frequency domain resources between an uplink subband and the downlink subband to enable the UE to filter out signals included in the uplink subband when receiving signals included in the downlink subband, among other examples. Based at least in part on receiving the indication that the UE supports downlink subband filtering within the bandwidth of the CC associated with the UE, the network entity may schedule one or more downlink communications for the UE in a slot associated with full-duplex operations.

Particular aspects of the subject matter described in this disclosure can be implemented to realize one or more of the following potential advantages. In some examples, the described techniques can be used to reduce interference caused by signals received by a UE in a bandwidth of a CC that are not associated with a downlink signal intended for the UE (for example, uplink signals transmitted by one or more other UEs using frequency domain resources that are included in the bandwidth of the CC and at a time that at least partially overlaps with time domain resources of the downlink signal). Additionally, the transmission, by a UE, of an indication of a capability associated with performing downlink subband filtering may enable a network entity to make improved scheduling decisions. For example, if a UE indicates that the UE is capable of performing downlink subband filtering, then the network entity may schedule the UE to receive a downlink communication in a slot associated with full-duplex operations (such as an SBFD slot) to improve resource utilization or to reduce latency (for example, because the UE is capable of mitigating negative effects caused by interfering signals transmitted by other devices in the slot associated with full-duplex operations by performing downlink subband filtering, as explained in more detail elsewhere herein). As another example, if a UE indicates that the UE is not capable of performing downlink subband filtering, then the network entity may schedule the UE to receive a downlink communication in a slot that is not associated with full-duplex operations (for example, full-duplex operations performed by the network entity) to reduce a likelihood of the UE experiencing interference caused by uplink transmissions from other UEs in the same slot that the UE is receiving a downlink communication.

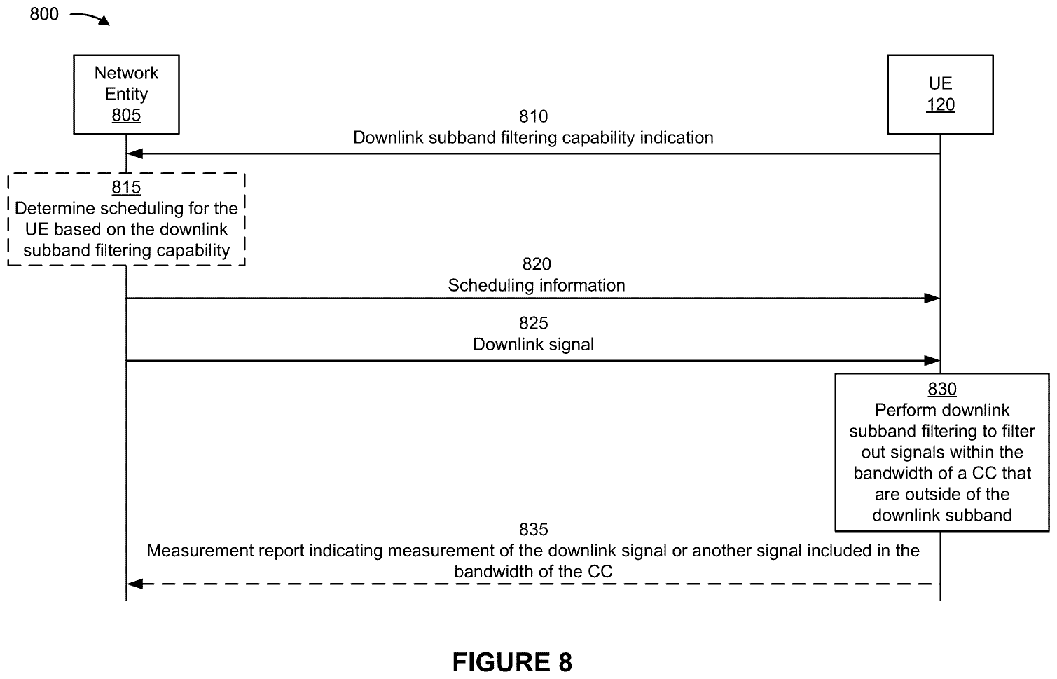

FIG. 8 is a diagram of an example associated with UE subband filtering 800, in accordance with the present disclosure. As shown in FIG. 8, a network entity 805 (for example, a base station 110, a CU, a DU, or an RU) may communicate with a UE (for example, a UE 120). In some aspects, the network entity 805 and the UE 120 may be part of a wireless network (for example, the wireless network 100). The UE 120 and the network entity 805 may have established a wireless connection prior to operations shown in FIG. 8. The network entity 805 may be operating in an SBFD mode (for example, transmitting and receiving at the same time on different frequency domain resources). In some aspects, the UE 120 may be operating in a half-duplex mode. In some other aspects, the UE 120 may be operating in a full-duplex mode.

In a first operation 810, the UE 120 may transmit (for example, to the network entity 805 or to another network entity, such as to an RU when the network entity 805 is a CU or a DU) an indication that the UE 120 supports downlink subband filtering within a bandwidth of a CC associated with the UE 120. The network entity 805 may receive (for example, from the UE 120 or from another network entity, such as from an RU when the network entity 805 is a CU or a DU) the indication that the UE 120 supports downlink subband filtering within a bandwidth of a CC associated with the UE 120. For example, the UE 120 may transmit an indication of whether the UE 120 is capable of performing subband filtering within a given channel or carrier (for example, in-channel filtering). For example, the capability may be defined in terms of “support” (for example, indicating that the UE 120 is capable of performing downlink subband filtering within a bandwidth of a given CC) or “no support” (for example, indicating that the UE 120 is not capable of performing downlink subband filtering within a bandwidth of a given CC).

The UE 120 may transmit the indication of the capability associated with downlink subband filtering in a capability report (for example, the indication may be included in a UE capability report). In some aspects, the indication of the capability associated with downlink subband filtering in a capability report may be included in an uplink control channel communication (for example, a physical uplink control channel (PUCCH) communication), an uplink shared channel or data channel communication (for example, a physical uplink shared channel (PUSCH) communication), uplink control information (UCI), a UE assistance information (UAI) communication, or another type of uplink communication.

In some aspects, the UE 120 may transmit the indication of the capability associated with downlink subband filtering on a feature set per CC (FSPC) basis (for example, an FSPC basis may be defined, or otherwise fixed, by a wireless communication standard, such as the 3GPP). “FSPC basis” may refer to the UE 120 reporting the capability for a given CC associated with a given band that is associated with a given band combination (for example, per CC, per band, and per band combination). In other words, the UE 120 may transmit the indication of the capability associated with downlink subband filtering per feature set per CC. Additionally or alternatively, the UE 120 may transmit the indication of the capability associated with downlink subband filtering on a feature set (FS) basis (for example, an FS basis may be defined, or otherwise fixed, by a wireless communication standard, such as the 3GPP). For example, the UE 120 may transmit the indication of the capability associated with downlink subband filtering for a given feature set. In other words, the UE 120 may transmit the indication of the capability associated with downlink subband filtering for a given band (per band) and for a given band combination (per band combination). Additionally or alternatively, the UE 120 may transmit the indication of the capability associated with downlink subband filtering on a frequency band basis. For example, the UE 120 may transmit the indication of the capability associated with downlink subband filtering for a given frequency band (per band).

In some aspects, if the UE 120 supports downlink subband filtering within a bandwidth of a configured CC or channel, the UE 120 may indicate additional information associated with the capability of the UE 120. For example, the UE 120 may indicate a quantity of downlink subbands, within the CC, that are supported by the UE 120. For example, the UE 120 may indicate whether a single downlink subband or multiple downlink subbands within the CC are supported by the UE 120. Additionally or alternatively, the UE 120 may indicate one or more supported quantities of frequency domain resources (for example, physical resource blocks (PRBs)) between subbands within the CC. For example, the UE 120 may indicate a first supported quantity of PRBs between subbands within the CC and a second supported quantity of PRBs between subbands within the CC. In some aspects, the first supported quantity may be a minimum quantity of PRBs between subbands within the bandwidth of the CC that is supported by the UE 120. In some aspects, the second supported quantity may be a maximum quantity of PRBs between subbands within the bandwidth of the CC that is supported by the UE 120. In other words, the UE 120 may indicate a minimum and a maximum separation in the frequency domain (for example, in terms of PRBs) between subbands included in the bandwidth of a given CC.

Additionally or alternatively, the UE 120 may indicate a bandwidth of each subband associated with a given CC. For example, the UE 120 may indicate a bandwidth of each subband in terms of frequency domain resources (for example, the UE 120 may indicate that, within a 100 MHz CC bandwidth, a downlink subband has a bandwidth of 20 MHz and an uplink subband has a bandwidth of 20 MHz, among other examples). In some aspects, the UE 120 may indicate a location (for example, a frequency domain location) of the downlink subband within the CC, such as the first RB or frequency resource. Additionally or alternatively, the UE 120 may indicate a supported quantity of frequency domain resources between an uplink subband and a downlink subband associated with the UE filtering out signals included in the uplink subband when receiving signals included in the downlink subband. For example, the UE 120 may indicate a quantity of PRBs (for example, a minimum separation in the frequency domain) that are needed between an uplink subband and a downlink subband (for example, included in the same CC) to enable the UE 120 to filter out signals included in the uplink subband when receiving a downlink signal in the downlink subband.

In some aspects, the network entity 805 may transmit (for example, to the UE 120 or to another network entity) configuration information. The UE 120 may receive (for example, from the network entity 805 or from another network entity) the configuration information. In some aspects, the UE 120 may receive the configuration information via one or more of radio resource control (RRC) signaling, one or more medium access control (MAC) control elements (MAC-CEs), or downlink control information (DCI), among other examples. In some aspects, the configuration information may include an indication of one or more configuration parameters (for example, stored by the UE 120 or previously indicated by the network entity 805 or another network device) for selection by the UE 120, or explicit configuration information for the UE 120 to use to configure itself, among other examples.

In some aspects, the configuration information may indicate whether the UE 120 is to perform downlink subband filtering, as explained in more detail elsewhere herein. For example, the configuration information may indicate that the UE 120 is to perform downlink subband filtering based at least in part on the UE 120 indicating that the UE 120 is capable of performing downlink subband filtering (for example, as indicated by the UE 120 in the first operation 810). In some aspects, the configuration information may indicate a quantity of subbands that are to be included in a given CC or channel that is configured for the UE 120. In some aspects, the configuration information may indicate a bandwidth or a frequency domain location of each subband configured for a given CC or channel.

The UE 120 may configure itself based at least in part on the configuration information. In some aspects, the UE 120 may be configured to perform one or more operations described herein based at least in part on the configuration information.

In some aspects, in a second operation 815, the network entity 805 may determine scheduling information for the UE 120 based at least in part on the downlink subband filtering capability of the UE 120 (for example, as indicated by the UE 120 in the first operation 810). For example, if the UE 120 indicates that the UE 120 is not capable of performing downlink subband filtering (for example, in the first operation 810), then the network entity 805 may determine that the UE 120 should not be scheduled to receive downlink communications in slots associated with full-duplex operations or uplink transmissions from other UEs (for example, to mitigate interference experienced by the UE 120). As another example, if the UE 120 indicates that the UE 120 is capable of performing downlink subband filtering (for example, in the first operation 810), then the network entity 805 may determine that the UE 120 may be scheduled to receive downlink communications in slots associated with full-duplex operations or uplink transmissions from other UEs (for example, for improved network resource utilization). For example, because the UE 120 may be capable of filtering out interfering signals included in the same CC or channel bandwidth as a downlink signal, the network entity 805 may determine that the UE 120 may be scheduled in a slot associated with other uplink signals transmitted by another UE (not shown in FIG. 8), such as an SBFD slot.

In some aspects, the network entity 805 may determine a type of slot or scheduling resource to use for a downlink signal intended for the UE 120 based at least in part on the downlink subband filtering capability of the UE 120. For example, if the UE 120 indicates that the UE 120 supports a single downlink subband within a bandwidth of a CC, then the network entity 805 may schedule the UE 120 to receive a downlink signal in a slot that is associated with a single downlink subband. As another example, if the UE 120 indicates that the UE 120 supports multiple downlink subbands within a bandwidth of a CC, then the network entity 805 may schedule the UE 120 to receive a downlink signal in a slot that is associated with multiple downlink subbands (for example, such as the SBFD slot depicted in FIG. 7 that is associated with two downlink subbands and one (a single) uplink subband).

In some aspects, in a third operation 820, the network entity 805 may transmit (for example, to the UE 120 or to another network entity) a communication scheduling a downlink signal for the UE 120 (for example, a downlink signal intended for the UE 120) associated with a CC in a slot associated with full-duplex operations or one or more resources for uplink signals transmitted by other UEs. The UE 120 may receive (for example, from the network entity 805 or from another network entity) the communications scheduling the downlink signal. For example, the communication scheduling the downlink signal may be a DCI communication. In some other aspects, the communication may be an RRC communication (for example, for periodic downlink signals) or a MAC-CE communication (for example, for semi-persistent downlink signals), among other examples. The slot may be an SBFD slot associated with one or more downlink subbands and one or more uplink subbands. In some aspects, the slot may be the slot determined by the network entity 805 in the second operation 815.

In a fourth operation 825, the network entity 805 may transmit (for example, to the UE 120 or to another network entity) the downlink signal intended for the UE 120. The UE 120 may receive (for example, from the network entity 805 or from another network entity) the downlink signal. The downlink signal may be received by the UE 120 in a downlink subband that is included in a bandwidth of a CC or a channel. The downlink signal may be received by the UE 120 in a slot associated with full-duplex operations, such as an SBFD slot or another slot.

In a fifth operation 830, the UE 120 may perform downlink subband filtering to filter out signals within the bandwidth of the CC that are associated with frequency domain resources not included within the downlink subband. For example, the UE 120 may selectively receive downlink signals in the downlink subband in the presence of other signal interference within the component channel based at least in part on performing the downlink subband filtering. For example, the UE 120 may isolate signals that are received within the downlink subband and may filter out (for example, suppress or reject) signals that are within the bandwidth of the CC or channel but are outside of the downlink subband. In some aspects, the fifth operation 830 may include filtering the bandwidth of the CC or channel so as to suppress signals outside of the downlink subband. In some aspects, the fifth operation 830 may include receiving the downlink signal in the downlink subband based at least in part on filtering out signals within the bandwidth of the CC that are associated with frequency domain resources not included within the downlink subband. In some aspects, performing the downlink subband filtering may be referred to as in-channel selectivity (ICS).

In some aspects, the UE 120 may be associated with an ICS value that indicates a measure of an amount of interference rejection caused by a signal received in an adjacent subband, to the downlink subband, within the bandwidth of the CC that can be filtered out by the UE 120. “Adjacent subband” may refer to a subband that is next to the downlink subband in the frequency domain. In some aspects, the ICS value may be a ratio of a first filter attenuation associated with the downlink subband to a second filter attenuation associated with the adjacent subband. In some aspects, the ICS value may be a ratio of a received power associated with the signal received in the adjacent subband to a power of the signal after the UE performs the downlink subband filtering associated with the downlink subband (for example, in the fifth operation 830). In other words, the ICS value may be a measure of the capability of the UE 120 to suppress signals outside of the downlink subband and within the same channel bandwidth of the downlink subband. For example, the ICS value may be considered to be a measure of the UE 120 receiver's ability to receive a signal at the assigned subband within a channel frequency in the presence of adjacent subband signal within same channel. The ICS value may be represented in terms of a quantity of decibels (dBs). For example, the ICS value may be 30 dB, 20 dB, 15 dB, or another value.

In some aspects, the UE 120 may transmit an indication of the ICS value associated with the UE 120. The network entity 805 may receive the indication of the ICS value associated with the UE 120. For example, the UE 120 may transmit the indication of the ICS value as part of the first operation 810. In some aspects, the ICS value may be defined, or otherwise fixed, by a wireless communication standard, such as the 3GPP. In some aspects, the ICS value may be based at least in part on a bandwidth of the downlink subband, a frequency separation between the downlink subband and an adjacent uplink subband or interfering signal, a power associated with the interfering signal, a bandwidth of the adjacent uplink subband (for example, that is associated with the interfering signal), or a subcarrier spacing (SCS) configured for the UE 120, among other examples. For example, different ICS values may be defined (for example, by a wireless communication standard, such as the 3GPP) or reported by the UE 120, where the ICS value of the UE 120 at a given time may depend on one or more factors, such as one or more of the factors described above.

In some aspects, a test may be defined (for example, by a wireless communication standard, such as the 3GPP) to measure or determine whether the UE 120 is performing in accordance with the ICS value associated with the UE 120. For example, the test may be a receiver sensitivity (REFSENSE) test. In some other examples, the test maybe a receiver throughput test for high MCS. For example, a receiver throughput test may be used in a similar manner to the REFSENSE test as described herein. The test may measure a capability of the UE 120 associated with receiving a signal in a downlink subband in the presence of interference (for example, another signal) in an adjacent subband within the same channel or CC bandwidth. In some aspects, the test may be associated with one or more parameters or guidelines. For example, a power of the interference (for example, in the adjacent subband) may be higher than the power of the downlink signal in the downlink subband. As another example, a bandwidth of the interference may or may not be the same as the bandwidth of the downlink subband. Different REFSENSE test requirements may be defined based at least in part on a frequency offset between the downlink signal (or the downlink subband) and the interfering signal (or the adjacent subband). Additionally, different REFSENSE test requirements may be defined for scenarios associated with one (a single) downlink subband or multiple non-contiguous downlink subbands.

For example, the downlink signal may be associated with a first transmission power. The downlink subband may be associated with a first bandwidth. The UE 120 may receive an interfering signal associated with another subband (for example, an uplink subband or an adjacent subband) within the same CC or channel bandwidth as the downlink subband. The interfering signal may be associated with a second transmission power. The other subband (for example, an uplink subband or an adjacent subband) may be associated with a second bandwidth. The downlink subband and the other subband are separated in a frequency domain by a quantity of frequency domain resources (for example, in terms of a quantity of PRBs or MHzs). The separation in the frequency domain between the other subband and the downlink subband may be referred to as a frequency offset or a frequency separation. As part of the test, the UE 120 may filter the downlink signal to reduce interference caused by the interfering signal (for example, as part of the fifth operation 830). In some aspects, the second transmission power may be greater than or equal to the first transmission power (for example, the transmission power of the interfering signal may be greater than the transmission power of the downlink signal to test the UE's 120 ability to mitigate the interference).

In some aspects, the first transmission power is based at least in part on a REFSENSE test value modified by a first value (for example, XdB). The REFSENSE test value may be defined, or otherwise fixed, by a wireless communication standard, such as the 3GPP. The first value (for example, XdB) may be based at least in part on the ICS value associated with the UE 120 (for example, different values for Xmay be defined for different ICS values). The second transmission power may be based at least in part on the REFSENSE test value modified by a second value (for example, Y dB). The second value (for example, Y dB) may be based at least in part on the ICS value associated with the UE 120 (for example, different values for Y may be defined for different ICS values). Additionally or alternatively, the second value (for example, Y dB) may be based at least in part on the first bandwidth of the downlink subband (for example, different values for Y may be defined for different bandwidths of the downlink subband). In some aspects, the second transmission power, the second bandwidth, or the quantity of frequency domain resources may be based at least in part on the first bandwidth.

Table 1 below defines example parameters or requirements of the REFSENSE test associated with testing the capability of the UE 120 associated with performing downlink subband filtering for ICS.

TABLE 1

| | | Downlink Subband Bandwidth | | | | |
|---|---|---|---|---|---|---|
| Parameter | Units | 10 MHz | 20 MHz | 30 MHz | 40 MHz | 50 MHz |
| Power in DL | dBm | REFSENSE + X dB | | | | |
| subband transmission | | | | | | |
| Power of interference | dBm | REF- | REF- | REF- | REF- | REF- |
| | | SENSE + | SENSE + | SENSE + | SENSE + | SENSE + |
| | | Y₁ dB | Y₂ dB | Y₃ dB | Y₄ dB | Y₅ dB |

| | | |
|---|---|---|
| BW of interference | MHz | 5 or 10 |
| Frequency offset | MHz | ±0, 1, or 2 |

As shown in Table 1, a power of a downlink (DL) subband transmission (for example, a transmission power of a downlink signal within the downlink subband) and a power of the interference (for example, a transmission power of an interfering signal) may be defined in terms of dB-milliwatts (dBm). Additionally, a bandwidth (BW) of the interference (for example, a bandwidth of an interfering signal or a subband that includes the interfering signal) and a frequency offset between the downlink subband and the subband that includes the interfering signal may be defined in terms of MHz.

In some aspects, the REFSENSE test value or the ICS value may be based at least in part on an operating configuration associated with the UE 120. For example, the operating configuration may include a frequency range. For example, different REFSENSE test values or ICS values may be defined for different frequency ranges (such as a first value for FR1 and a second value for FR2). Additionally or alternatively, the operating configuration may include a sub-frequency range. For example, different REFSENSE test values or ICS values may be defined for different sub-frequency ranges (such as a first value for 3.3-3.8 GHz and a second value for 700-900 MHz). Additionally or alternatively, the operating configuration may include a type of network configuration, such as a non-terrestrial network (NTN) configuration, a terrestrial network configuration, a licensed frequency band configuration, an unlicensed frequency band configuration, or a sidelink configuration, among other examples. For example, different REFSENSE test values or ICS values may be defined for types of network configurations. Additionally or alternatively, the operating configuration may include a carrier aggregation configuration. For example, different REFSENSE test values or the ICS values may be defined for different carrier aggregation configurations (such as a first value for intra-band carrier aggregation configurations and a second value for inter-band carrier aggregation configurations). Additionally or alternatively, the operating configuration may include a dual connectivity configuration. For example, different REFSENSE test values or ICS values may be defined for different dual connectivity configurations (such as a first value for NR dual connectivity (NR-DC) configurations and a second value for Evolved Universal Mobile Telecommunications System Terrestrial Radio Access (E-UTRA)-NR dual connectivity (ENDC) configurations). Additionally or alternatively, the operating configuration may include a TRP configuration. For example, different REFSENSE test values or ICS values may be defined for different TRP configurations (such as a first value for single TRP configurations and a second value for multiple TRP (multi-TRP) configurations). Additionally or alternatively, the operating configuration may include a transmission configuration indicator (TCI) state configuration. For example, different REFSENSE test values or the ICS values may be defined for different TCI state configurations (such as a first value for single TCI state configurations and a second value for multiple TCI state configurations).

In some aspects, in a sixth operation 835, the UE 120 may transmit (for example, to the network entity 805 or to another network entity) a measurement report. The network entity 805 may receive (for example, from the UE 120 or from another network entity) the measurement report. The measurement report may include a measurement of the downlink signal received by the UE 120. Additionally or alternatively, the measurement report may include a measurement of another signal (for example, an interfering signal) that was transmitted in the same channel or CC bandwidth as the downlink signal. For example, the UE 120 may transmit the measurement report indicating a measurement of the interfering signal in the same channel or CC bandwidth as the downlink signal. The measurement of the interfering signal may enable the network entity 805 to identify a measure of the UE's 120 capability to suppress or mitigate in-channel interference by performing downlink subband filtering (for example, in the fifth operation 830).

In some aspects, the measurement report may be a cross-link interference (CLI) measurement report. For example, the UE 120 may perform downlink subband filtering to suppress or mitigate an interfering signal associated with CLI and may measure the signal after performing the downlink subband filtering. The UE 120 may indicate the measurement of the interfering signal in a CLI measurement report. The network entity 805 may identify that the UE 120 is not impacted by CLI (or that the UE 120 is capable of mitigating CLI) based on the measurement of the interfering signal in the CLI measurement report. For example, in some cases, rather than the UE 120 explicitly indicating that the UE supports downlink subband filtering (for example, as was indicated in the first operation 810), the UE 120 may implicitly indicate that the UE supports downlink subband filtering by indicating a measurement of an interfering signal (for example, that is transmitted in a CLI measurement resource) after filtering out the signal by performing downlink subband filtering (for example, in the fifth operation 830). As a result, the UE 120 may indicate a low measurement value associated with the interfering signal (for example, based at least in part on filtering out the interfering signal), thereby indicating to the network entity 805 that the UE 120 is capable of handling the CLI. The network entity 805 may schedule the UE 120 in slots associated with full-duplex operations (for example, in the second operation 815) based at least in part on the low measurement value associated with the interfering signal indicated in the CLI measurement report. Therefore, the indication that the UE 120 supports downlink subband filtering within a bandwidth of a given CC may be based at least in part on a CLI measurement report.

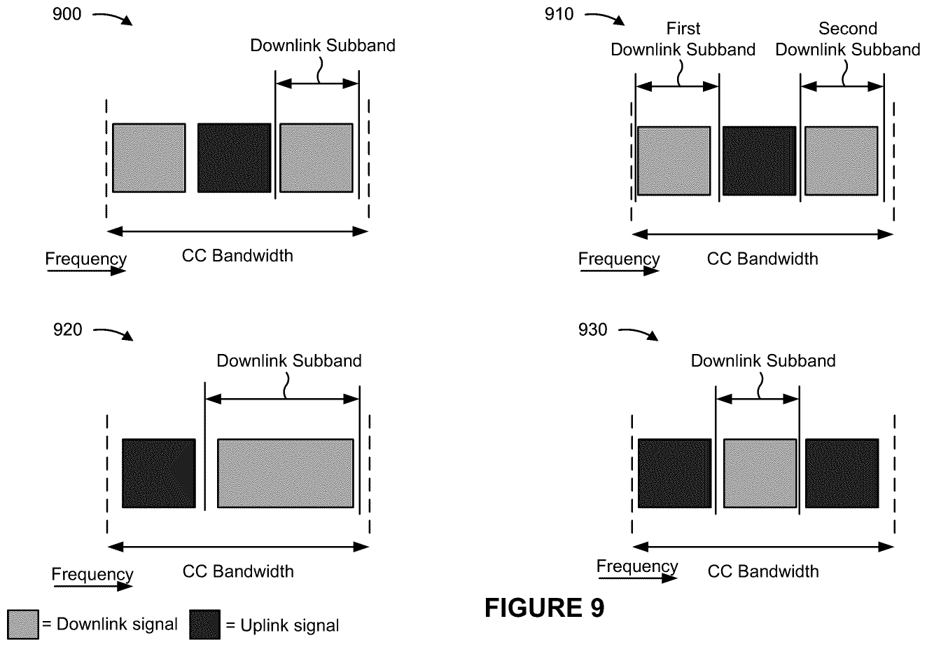

FIG. 9 is a diagram of an example associated with downlink subbands within a bandwidth of a CC, in accordance with the present disclosure. As described in more detail elsewhere herein, a UE 120 may be capable of performing downlink subband filtering to isolate signals within a downlink subband and filter out signals within the bandwidth of the CC that are outside of the downlink subband. In some aspects, the frequency domain locations of downlink signals or uplink signals within the bandwidth of the CC (for example, as depicted in FIG. 9) may be based at least in part on a configuration of the CC or a slot configuration (for example, an SBFD slot configuration).

In a first CC configuration 900, the UE 120 may support a single downlink subband (for example, may only support a single downlink subband filter). As shown in FIG. 9, the CC bandwidth may also include frequency domain resources associated with uplink signals (for example, an uplink subband) and other frequency domain resources associated with downlink resources. In the first CC configuration 900, the UE 120 may only support a single downlink subband filter. Therefore, when performing downlink subband filtering (such as in the fifth operation 830), the UE 120 may filter out signals received by the UE 120 in the frequency domain resources associated with the uplink signals (for example, the uplink subband) and the other frequency domain resources associated with downlink resources. The UE 120 may isolate signals received in the downlink subband to improve communication performance and to mitigate interference.

In a second CC configuration 910, the UE 120 may support multiple downlink subbands (for example, may support multiple downlink subband filters). As shown in FIG. 9 and the second CC configuration 910, the CC bandwidth may include a first downlink subband, an uplink subband, and a second downlink subband. The UE 120 may support multiple downlink subband filters. Therefore, the UE 120 may be capable of isolating signals received in the first downlink subband and the second downlink subband. Additionally, the UE 120 may be capable of filtering out signals received in the uplink subband (for example, to reduce interference with signals received in the first downlink subband or in the second downlink subband).

In a third CC configuration 920, the CC bandwidth may include a downlink subband and an uplink subband. In the third CC configuration 920, the UE 120 may support a single downlink subband filter. For example, the UE 120 may be capable of isolating signals received in the downlink subband and filtering out signals received in the uplink subband, such as in the fifth operation 830 (for example, to reduce interference with signals received in the downlink subband). In a fourth CC configuration 930, the CC bandwidth may include a downlink subband, a first uplink subband, and a second uplink subband. In some aspects, in the fourth CC configuration 930, the UE 120 may support a single downlink subband filter. For example, the UE 120 may be capable of isolating signals received in the downlink subband and filtering out signals received in the first uplink subband and the second uplink subband, such as in the fifth operation 830 (for example, to reduce interference with signals received in the downlink subband). The CC configurations, quantity of subbands, or subband frequency domain locations depicted in FIG. 9 are provided as examples. In practice, the UE 120 may be capable of performing downlink subband filtering, in a similar manner as described herein, with other CC configurations, different quantities of subbands, different quantities of subband filters (for example, three or more subband filters), or different subband frequency domain locations, among other examples.

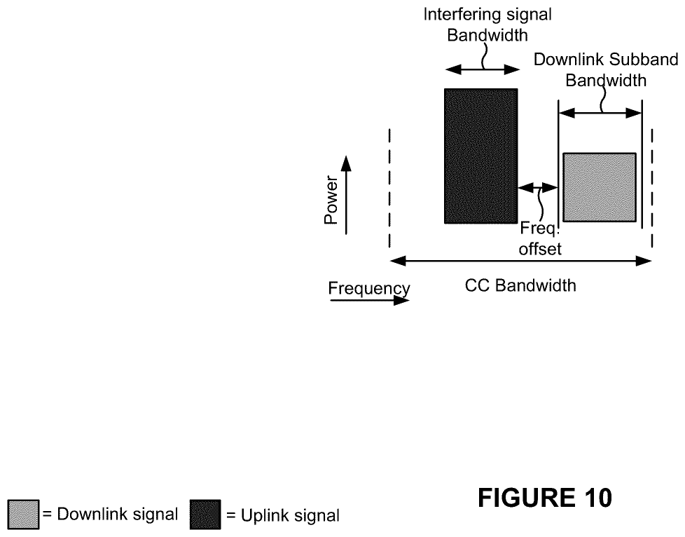

FIG. 10 is a diagram of an example associated with parameters associated with downlink subband filtering, in accordance with the present disclosure. For example, in some aspects, the parameters depicted in FIG. 10 may be defined, or otherwise fixed, for a test, such as a REFSENSE test (for example, as described in more detail elsewhere herein, such as in connection with FIG. 8). In some other aspects, the parameters depicted in FIG. 10 may be associated with the UE 120 performing downlink subband filtering, as described in more detail elsewhere herein, such as in connection with FIG. 8.

As shown in FIG. 10, a bandwidth of a CC (a carrier or channel) may include a downlink subband and another subband (for example, that includes an interfering signal, such as an uplink signal transmitted by another UE). The downlink subband may be associated with a first bandwidth. The other subband (or the interfering signal) may be associated with a second bandwidth. The first bandwidth and the second bandwidth may both be included in the bandwidth of the CC.

As shown in FIG. 10, the other subband (or the interfering signal) and the downlink subband may be separated in the frequency domain by a frequency offset (shown as “Freq. offset” in FIG. 10). The frequency offset may be defined in terms of MHz or a quantity of PRBs. In other examples, there may be an additional interfering signal or adjacent subband to the downlink subband (for example, located next to the downlink subband or next to the interfering signal subband). Additionally or alternatively, there may be an additional downlink subband (for example, when the UE 120 is capable of supporting multiple downlink subband filters). The additional downlink subband may be separated from the other subband (or the interfering signal) by the frequency offset. Alternatively, the additional downlink subband may be separated from the downlink subband by the frequency offset.

FIG. 11 is a flowchart illustrating an example process 1100 performed, for example, by a UE, associated with UE subband filtering, in accordance with the present disclosure. Example process 1100 is an example where the UE (for example, the UE 120) performs operations associated with UE subband filtering.

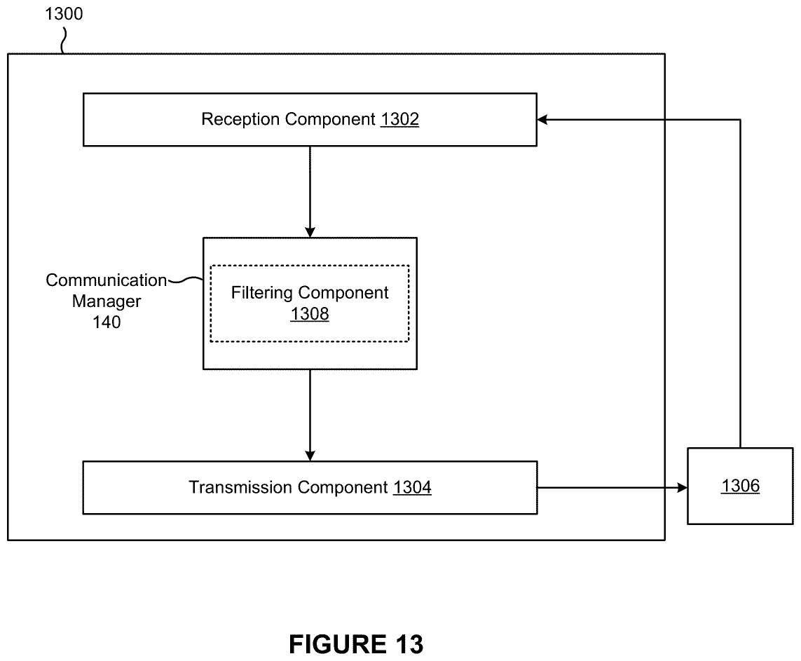

As shown in FIG. 11, in some aspects, process 1100 may include transmitting, to a network entity, an indication that the UE supports downlink subband filtering within a bandwidth of a CC associated with the UE (block 1110). For example, the UE (such as by using communication manager 140 or transmission component 1304, depicted in FIG. 13) may transmit, to a network entity, an indication that the UE supports downlink subband filtering within a bandwidth of a CC associated with the UE, as described above.

As further shown in FIG. 11, in some aspects, process 1100 may include receiving, from the network entity and based on transmitting the indication, a downlink signal within a downlink subband that is included in the bandwidth of the CC based on filtering out signals within the bandwidth of the CC that are associated with frequency domain resources not included within the downlink subband (block 1120). For example, the UE (such as by using communication manager 140 or reception component 1302, depicted in FIG. 13) may receive, from the network entity and based on transmitting the indication, a downlink signal within a downlink subband that is included in the bandwidth of the CC based on filtering out signals within the bandwidth of the CC that are associated with frequency domain resources not included within the downlink subband, as described above.

Process 1100 may include additional aspects, such as any single aspect or any combination of aspects described below or in connection with one or more other processes described elsewhere herein.

In a first additional aspect, the indication is included in a UE capability report.

In a second additional aspect, alone or in combination with the first aspect, the indication that the UE supports downlink subband filtering within the bandwidth of the CC includes an indication of at least one of a quantity of downlink subbands, within the CC, that are supported by the UE, whether a single downlink subband or multiple downlink subbands within the CC are supported by the UE, a first supported quantity of frequency domain resources between subbands within the CC, a second supported quantity of frequency domain resources between subbands within the CC, a bandwidth of each subband associated with the CC, or a third supported quantity of frequency domain resources between an uplink subband and the downlink subband associated with the UE filtering out signals included in the uplink subband when receiving signals included in the downlink subband.

In a third additional aspect, alone or in combination with one or more of the first and second aspects, transmitting the indication includes transmitting the indication on at least one of an FSPC basis, an FS basis, or a frequency band basis.

In a fourth additional aspect, alone or in combination with one or more of the first through third aspects, process 1100 includes receiving, from the network entity and based at least in part on transmitting the indication, a communication scheduling the downlink signal in an SBFD slot associated with one or more downlink subbands including the downlink subband, and one or more uplink subbands.

In a fifth additional aspect, alone or in combination with one or more of the first through fourth aspects, the UE is associated with an ICS value that indicates a measure of an amount of interference rejection caused by a signal received in an adjacent subband, to the downlink subband, within the bandwidth of the CC that can be filtered out by the UE.

In a sixth additional aspect, alone or in combination with one or more of the first through fifth aspects, the ICS value is a ratio of a first filter attenuation associated with the downlink subband to a second filter attenuation associated with the adjacent subband.

In a seventh additional aspect, alone or in combination with one or more of the first through sixth aspects, the ICS value is a ratio of a received power associated with the signal received in the adjacent subband to a power of the signal after the UE performs the filtering associated with the downlink subband.

In an eighth additional aspect, alone or in combination with one or more of the first through seventh aspects, process 1100 includes transmitting, to the network entity, an indication of the ICS value.

In a ninth additional aspect, alone or in combination with one or more of the first through eighth aspects, the downlink signal is associated with a first transmission power, the downlink subband is associated with a first bandwidth, and receiving the downlink signal includes receiving an interfering signal associated with another subband within the CC, where the interfering signal is associated with a second transmission power, where the other subband is associated with a second bandwidth, and where the downlink subband and the other subband are separated in a frequency domain by a quantity of frequency domain resources, and filtering the downlink signal to reduce interference caused by the interfering signal.

In a tenth additional aspect, alone or in combination with one or more of the first through ninth aspects, the second transmission power is greater than or equal to the first transmission power.

In an eleventh additional aspect, alone or in combination with one or more of the first through tenth aspects, the first transmission power is based at least in part on a REFSENSE test value modified by a first value, where the first value is based at least in part on the ICS value.

In a twelfth additional aspect, alone or in combination with one or more of the first through eleventh aspects, the second transmission power is based at least in part on the REFSENSE test value modified by a second value, where the second value is based at least in part on the ICS value.

In a thirteenth additional aspect, alone or in combination with one or more of the first through twelfth aspects, the REFSENSE test value is based at least in part on an operating configuration associated with the UE, where the operating configuration includes at least one of a frequency range, a sub-frequency range, a non-terrestrial network configuration, a terrestrial network configuration, a licensed frequency band configuration, an unlicensed frequency band configuration, a sidelink configuration, an intra-band carrier aggregation configuration, an inter-band carrier aggregation configuration, a dual connectivity configuration, a TRP configuration, or a TCI state configuration.

In a fourteenth additional aspect, alone or in combination with one or more of the first through thirteenth aspects, at least one of the second transmission power, the second bandwidth, or the quantity of frequency domain resources is based at least in part on the first bandwidth.

In a fifteenth additional aspect, alone or in combination with one or more of the first through fourteenth aspects, process 1100 includes transmitting, to the network entity, a measurement report indicating a measurement of the interfering signal.

In a sixteenth additional aspect, alone or in combination with one or more of the first through fifteenth aspects, the ICS value is based at least in part on an operating configuration associated with the UE, where the operating configuration includes at least one of a frequency range, a sub-frequency range, a non-terrestrial network configuration, a terrestrial network configuration, a licensed frequency band configuration, an unlicensed frequency band configuration, a sidelink configuration, an intra-band carrier aggregation configuration, an inter-band carrier aggregation configuration, a dual connectivity configuration, a TRP configuration, or a TCI state configuration.

In a seventeenth additional aspect, alone or in combination with one or more of the first through sixteenth aspects, the indication is based at least in part on a CLI measurement report.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a flowchart illustrating an example process 1200 performed, for example, by a network entity, associated with UE subband filtering, in accordance with the present disclosure. Example process 1200 is an example where the network entity (for example, the network entity 805, a base station 110, a CU, a DU, or an RU) performs operations associated with UE subband filtering.

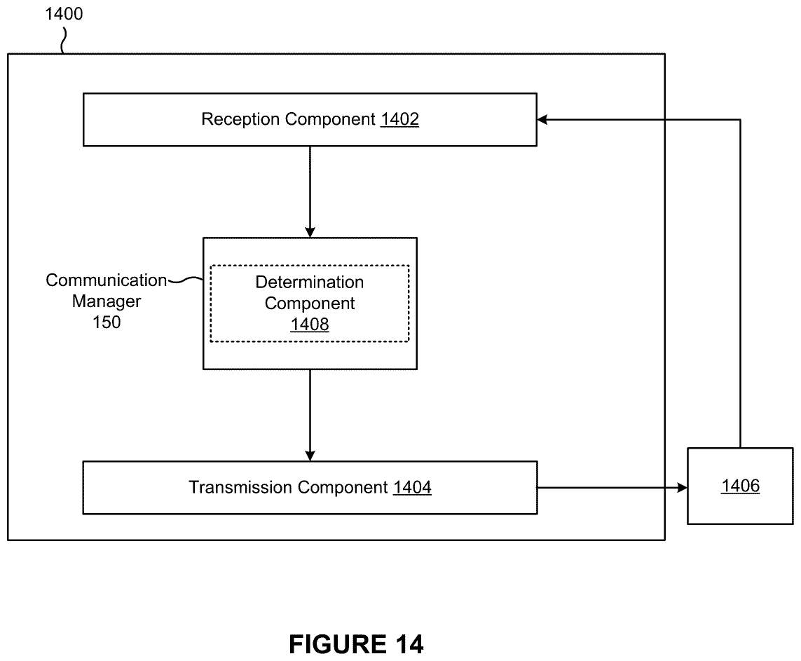

As shown in FIG. 12, in some aspects, process 1200 may include receiving an indication that a UE supports downlink subband filtering within a bandwidth of a CC associated with the UE (block 1210). For example, the network entity (such as by using communication manager 150 or reception component 1402, depicted in FIG. 14) may receive an indication that a UE supports downlink subband filtering within a bandwidth of a CC associated with the UE, as described above.

As further shown in FIG. 12, in some aspects, process 1200 may include transmitting, based on receiving the indication, a communication scheduling a downlink signal for the UE associated with the CC in a slot associated with full-duplex operations (block 1220). For example, the network entity (such as by using communication manager 150 or transmission component 1404, depicted in FIG. 14) may transmit, based on receiving the indication, a communication scheduling a downlink signal for the UE associated with the CC in a slot associated with full-duplex operations, as described above.

Process 1200 may include additional aspects, such as any single aspect or any combination of aspects described below or in connection with one or more other processes described elsewhere herein.

In a first additional aspect, process 1200 includes transmitting the downlink signal intended for the UE.

In a second additional aspect, alone or in combination with the first aspect, the indication is included in a UE capability report.

In a third additional aspect, alone or in combination with one or more of the first and second aspects, the indication that the UE supports downlink subband filtering within the bandwidth of the CC includes an indication of at least one of a quantity of downlink subbands, within the CC, that are supported by the UE, whether a single downlink subband or multiple downlink subbands within the CC are supported by the UE, a first supported quantity of frequency domain resources between subbands within the CC, a second supported quantity of frequency domain resources between subbands within the CC, a bandwidth of each subband associated with the CC, or a third supported quantity of frequency domain resources between an uplink subband and the downlink subband associated with the UE filtering out signals included in the uplink subband when receiving signals included in the downlink subband.

In a fourth additional aspect, alone or in combination with one or more of the first through third aspects, receiving the indication includes receiving the indication on at least one of an FSPC basis, an FS basis, or a frequency band basis.

In a fifth additional aspect, alone or in combination with one or more of the first through fourth aspects, the slot is an SBFD slot associated with one or more downlink subbands and one or more uplink subbands.

In a sixth additional aspect, alone or in combination with one or more of the first through fifth aspects, the UE is associated with an ICS value that indicates a measure of an amount of interference rejection caused by a signal received in an adjacent subband, to a downlink subband associated with the downlink signal, within the CC that can be filtered out by the UE.

In a seventh additional aspect, alone or in combination with one or more of the first through sixth aspects, the ICS value is a ratio of a first filter attenuation associated with the downlink subband to a second filter attenuation associated with the adjacent subband.

In an eighth additional aspect, alone or in combination with one or more of the first through seventh aspects, the ICS value is a ratio of a received power associated with the signal received in the adjacent subband to a power of the signal after the UE performs the filtering associated with the downlink subband.

In a ninth additional aspect, alone or in combination with one or more of the first through eighth aspects, process 1200 includes receiving an indication of the ICS value.

In a tenth additional aspect, alone or in combination with one or more of the first through ninth aspects, the downlink signal is associated with a first transmission power, a downlink subband associated with the downlink signal is associated with a first bandwidth, and process 1200 includes transmitting an interfering signal associated with another subband within the CC, where the interfering signal is associated with a second transmission power, where the other subband is associated with a second bandwidth, and where the downlink subband and the other subband are separated in a frequency domain by a quantity of frequency domain resources.

In an eleventh additional aspect, alone or in combination with one or more of the first through tenth aspects, the second transmission power is greater than or equal to the first transmission power.

In a twelfth additional aspect, alone or in combination with one or more of the first through eleventh aspects, the first transmission power is based at least in part on a REFSENSE test value modified by a first value, where the first value is based at least in part on the ICS value.

In a thirteenth additional aspect, alone or in combination with one or more of the first through twelfth aspects, the second transmission power is based at least in part on the REFSENSE test value modified by a second value, where the second value is based at least in part on the ICS value.

In a fourteenth additional aspect, alone or in combination with one or more of the first through thirteenth aspects, the REFSENSE test value is based at least in part on an operating configuration associated with the UE, where the operating configuration includes at least one of a frequency range, a sub-frequency range, a non-terrestrial network configuration, a terrestrial network configuration, a licensed frequency band configuration, an unlicensed frequency band configuration, a sidelink configuration, an intra-band carrier aggregation configuration, an inter-band carrier aggregation configuration, a dual connectivity configuration, a TRP configuration, or a TCI state configuration.

In a fifteenth additional aspect, alone or in combination with one or more of the first through fourteenth aspects, at least one of the second transmission power, the second bandwidth, or the quantity of frequency domain resources is based at least in part on the first bandwidth.

In a sixteenth additional aspect, alone or in combination with one or more of the first through fifteenth aspects, process 1200 includes receiving a measurement report indicating a measurement of the interfering signal performed by the UE.

In a seventeenth additional aspect, alone or in combination with one or more of the first through sixteenth aspects, the ICS value is based at least in part on an operating configuration associated with the UE, where the operating configuration includes at least one of a frequency range, a sub-frequency range, a non-terrestrial network configuration, a terrestrial network configuration, a licensed frequency band configuration, an unlicensed frequency band configuration, a sidelink configuration, an intra-band carrier aggregation configuration, an inter-band carrier aggregation configuration, a dual connectivity configuration, a TRP configuration, or a TCI state configuration.

In an eighteenth additional aspect, alone or in combination with one or more of the first through seventeenth aspects, the indication is based at least in part on a CLI measurement report.

Although FIG. 12 shows example blocks of process 1200, in some aspects, process 1200 may include additional blocks, fewer blocks, different blocks, or differently arranged blocks than those depicted in FIG. 12. Additionally or alternatively, two or more of the blocks of process 1200 may be performed in parallel.

FIG. 13 is a diagram of an example apparatus 1300 for wireless communication in accordance with the present disclosure. The apparatus 1300 may be a UE, or a UE may include the apparatus 1300. In some aspects, the apparatus 1300 includes a reception component 1302, a transmission component 1304, and a communication manager 140, which may be in communication with one another (for example, via one or more buses). As shown, the apparatus 1300 may communicate with another apparatus 1306 (such as a UE, a base station, a network entity, or another wireless communication device) using the reception component 1302 and the transmission component 1304.

In some aspects, the apparatus 1300 may be configured to perform one or more operations described herein in connection with FIGS. 8-10. Additionally or alternatively, the apparatus 1300 may be configured to perform one or more processes described herein, such as process 1100 of FIG. 11, or a combination thereof. In some aspects, the apparatus 1300 may include one or more components of the UE described above in connection with FIG. 2.

The reception component 1302 may receive communications, such as reference signals, control information, data communications, or a combination thereof, from the apparatus 1306. The reception component 1302 may provide received communications to one or more other components of the apparatus 1300, such as the communication manager 140. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1302 may include one or more antennas, a modem, a demodulator, a MIMO detector, a receive processor, a controller/processor, a memory, or a combination thereof, of the UE described above in connection with FIG. 2.

The transmission component 1304 may transmit communications, such as reference signals, control information, data communications, or a combination thereof, to the apparatus 1306. In some aspects, the communication manager 140 may generate communications and may transmit the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described above in connection with FIG. 2. In some aspects, the transmission component 1304 may be co-located with the reception component 1302 in a transceiver.

The communication manager 140 may transmit or may cause the transmission component 1304 to transmit, to a network entity, an indication that the apparatus 1300 supports downlink subband filtering within a bandwidth of a CC associated with the apparatus 1300. The communication manager 140 may receive or may cause the reception component 1302 to receive, from the network entity and based on transmitting the indication, a downlink signal within a downlink subband that is included in the bandwidth of the CC based on filtering out signals within the bandwidth of the CC that are associated with frequency domain resources not included within the downlink subband. In some aspects, the communication manager 140 may perform one or more operations described elsewhere herein as being performed by one or more components of the communication manager 140.

The communication manager 140 may include a controller/processor, a memory, or a combination thereof, of the UE described above in connection with FIG. 2. In some aspects, the communication manager 140 includes a set of components, such as a filtering component 1308, or a combination thereof. Alternatively, the set of components may be separate and distinct from the communication manager 140. In some aspects, one or more components of the set of components may include or may be implemented within a controller/processor, a memory, or a combination thereof, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 1304 may transmit, to a network entity, an indication that the apparatus 1300 supports downlink subband filtering within a bandwidth of a CC associated with the apparatus 1300. The reception component 1302 may receive, from the network entity and based on transmitting the indication, a downlink signal within a downlink subband that is included in the bandwidth of the CC based on filtering out signals within the bandwidth of the CC that are associated with frequency domain resources not included within the downlink subband.

The filtering component 1308 may filter the bandwidth of the CC to isolate signals included in the downlink subband and to filter out the signals within the bandwidth of the CC that are associated with frequency domain resources not included within the downlink subband.

The reception component 1302 may receive, from the network entity and based at least in part on transmitting the indication, a communication scheduling the downlink signal in an SBFD slot associated with one or more downlink subbands including the downlink subband, and one or more uplink subbands.

The transmission component 1304 may transmit, to the network entity, an indication of the ICS value.

The transmission component 1304 may transmit, to the network entity, a measurement report indicating a measurement of the interfering signal.

The quantity and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

FIG. 14 is a diagram of an example apparatus 1400 for wireless communication in accordance with the present disclosure. The apparatus 1400 may be a network entity, or a network entity may include the apparatus 1400. In some aspects, the apparatus 1400 includes a reception component 1402, a transmission component 1404, and a communication manager 150, which may be in communication with one another (for example, via one or more buses). As shown, the apparatus 1400 may communicate with another apparatus 1406 (such as a UE, a base station, a network entity, or another wireless communication device) using the reception component 1402 and the transmission component 1404.

In some aspects, the apparatus 1400 may be configured to perform one or more operations described herein in connection with FIGS. 8-10. Additionally or alternatively, the apparatus 1400 may be configured to perform one or more processes described herein, such as process 1200 of FIG. 12, or a combination thereof. In some aspects, the apparatus 1400 may include one or more components of the network entity described above in connection with FIG. 2.

The reception component 1402 may receive communications, such as reference signals, control information, data communications, or a combination thereof, from the apparatus 1406. The reception component 1402 may provide received communications to one or more other components of the apparatus 1400, such as the communication manager 150. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1402 may include one or more antennas, a modem, a demodulator, a MIMO detector, a receive processor, a controller/processor, a memory, or a combination thereof, of the network entity described above in connection with FIG. 2.

The transmission component 1404 may transmit communications, such as reference signals, control information, data communications, or a combination thereof, to the apparatus 1406. In some aspects, the communication manager 150 may generate communications and may transmit the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the network entity described above in connection with FIG. 2. In some aspects, the transmission component 1404 may be co-located with the reception component 1402 in a transceiver.

The communication manager 150 may receive or may cause the reception component 1402 to receive an indication that a UE supports downlink subband filtering within a bandwidth of a CC associated with the UE. The communication manager 150 may transmit or may cause the transmission component 1404 to transmit, based on receiving the indication, a communication scheduling a downlink signal for the UE associated with the CC in a slot associated with full-duplex operations. In some aspects, the communication manager 150 may perform one or more operations described elsewhere herein as being performed by one or more components of the communication manager 150.

The communication manager 150 may include a controller/processor, a memory, a scheduler, a communication unit, or a combination thereof, of the network entity described above in connection with FIG. 2. In some aspects, the communication manager 150 includes a set of components, such as a determination component 1408, or a combination thereof. Alternatively, the set of components may be separate and distinct from the communication manager 150. In some aspects, one or more components of the set of components may include or may be implemented within a controller/processor, a memory, a scheduler, a communication unit, or a combination thereof, of the network entity described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive an indication that a UE supports downlink subband filtering within a bandwidth of a CC associated with the UE. The transmission component 1404 may transmit, based on receiving the indication, a communication scheduling a downlink signal for the UE associated with the CC in a slot associated with full-duplex operations.

The transmission component 1404 may transmit the downlink signal intended for the UE.

The reception component 1402 may receive an indication of the ICS value.

The reception component 1402 may receive a measurement report indicating a measurement of the interfering signal performed by the UE.

The determination component 1408 may determine a scheduling of the downlink signal based at least in part on whether the UE supports downlink subband filtering within the bandwidth of the CC.

The quantity and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: transmitting, to a network entity, an indication that the UE supports downlink subband filtering within a bandwidth of a component carrier (CC) associated with the UE; and receiving, from the network entity and based on transmitting the indication, a downlink signal within a downlink subband that is included in the bandwidth of the CC based on filtering out signals within the bandwidth of the CC that are associated with frequency domain resources not included within the downlink subband.

Aspect 2: The method of Aspect 1, wherein the indication is included in a UE capability report.

Aspect 3: The method of any of Aspects 1-2, wherein the indication that the UE supports downlink subband filtering within the bandwidth of the CC includes an indication of at least one of: a quantity of downlink subbands, within the CC, that are supported by the UE, whether a single downlink subband or multiple downlink subbands within the CC are supported by the UE, a first supported quantity of frequency domain resources between subbands within the CC, a second supported quantity of frequency domain resources between subbands within the CC, a bandwidth of each subband associated with the CC, or a third supported quantity of frequency domain resources between an uplink subband and the downlink subband associated with the UE filtering out signals included in the uplink subband when receiving signals included in the downlink subband.

Aspect 4: The method of any of Aspects 1-3, wherein transmitting the indication comprises transmitting the indication on at least one of a feature set per CC (FSPC) basis, a feature set (FS) basis, or a frequency band basis.

Aspect 5: The method of any of Aspects 1-4, further comprising receiving, from the network entity and based at least in part on transmitting the indication, a communication scheduling the downlink signal in a subband full-duplex (SBFD) slot associated with one or more downlink subbands including the downlink subband, and one or more uplink subbands.

Aspect 6: The method of any of Aspects 1-5, wherein the UE is associated with an in-channel selectivity (ICS) value that indicates a measure of an amount of interference rejection caused by a signal received in an adjacent subband, to the downlink subband, within the bandwidth of the CC that can be filtered out by the UE.

Aspect 7: The method of Aspect 6, wherein the ICS value is a ratio of a first filter attenuation associated with the downlink subband to a second filter attenuation associated with the adjacent subband.

Aspect 8: The method of any of Aspects 6-7, wherein the ICS value is a ratio of a received power associated with the signal received in the adjacent subband to a power of the signal after the UE performs the filtering associated with the downlink subband.

Aspect 9: The method of any of Aspects 6-8, further comprising transmitting, to the network entity, an indication of the ICS value.

Aspect 10: The method of any of Aspects 1-9, wherein the downlink signal is associated with a first transmission power, wherein the downlink subband is associated with a first bandwidth, and wherein receiving the downlink signal comprises: receiving an interfering signal associated with another subband within the CC, wherein the interfering signal is associated with a second transmission power, wherein the other subband is associated with a second bandwidth, and wherein the downlink subband and the other subband are separated in a frequency domain by a quantity of frequency domain resources; and filtering the downlink signal to reduce interference caused by the interfering signal.

Aspect 11: The method of Aspect 10, wherein the second transmission power is greater than or equal to the first transmission power.

Aspect 12: The method of any of Aspects 10-11, wherein the first transmission power is based at least in part on a receiver sensitivity (REFSENSE) test value modified by a first value, wherein the first value is based at least in part on the ICS value.

Aspect 13: The method of Aspect 12, wherein the second transmission power is based at least in part on the REFSENSE test value modified by a second value, wherein the second value is based at least in part on the ICS value.

Aspect 14: The method of any of Aspects 12-13, wherein the REFSENSE test value is based at least in part on an operating configuration associated with the UE, wherein the operating configuration includes at least one of: a frequency range, a sub-frequency range, a non-terrestrial network configuration, a terrestrial network configuration, a licensed frequency band configuration, an unlicensed frequency band configuration, a sidelink configuration, an intra-band carrier aggregation configuration, an inter-band carrier aggregation configuration, a dual connectivity configuration, a transmit receive point (TRP) configuration, or a transmission configuration indicator (TCI) state configuration.

Aspect 15: The method of any of Aspects 10-14, wherein at least one of the second transmission power, the second bandwidth, or the quantity of frequency domain resources is based at least in part on the first bandwidth.

Aspect 16: The method of any of Aspects 10-15, further comprising transmitting, to the network entity, a measurement report indicating a measurement of the interfering signal.

Aspect 17: The method of any of Aspects 9-16, wherein the ICS value is based at least in part on an operating configuration associated with the UE, wherein the operating configuration includes at least one of: a frequency range, a sub-frequency range, a non-terrestrial network configuration, a terrestrial network configuration, a licensed frequency band configuration, an unlicensed frequency band configuration, a sidelink configuration, an intra-band carrier aggregation configuration, an inter-band carrier aggregation configuration, a dual connectivity configuration, a transmit receive point (TRP) configuration, or a transmission configuration indicator (TCI) state configuration.

Aspect 18: The method of any of Aspects 1-17, wherein the indication is based at least in part on a cross-link interference (CLI) measurement report.

Aspect 19: A method of wireless communication performed by a network entity, comprising: receiving an indication that a user equipment (UE) supports downlink subband filtering within a bandwidth of a component carrier (CC) associated with the UE; and transmitting, based on receiving the indication, a communication scheduling a downlink signal for the UE associated with the CC in a slot associated with full-duplex operations.

Aspect 20: The method of Aspect 19 further comprising transmitting the downlink signal intended for the UE.

Aspect 21: The method of any of Aspects 19-20, wherein the indication is included in a UE capability report.

Aspect 22: The method of any of Aspects 19-21, wherein the indication that the UE supports downlink subband filtering within the bandwidth of the CC includes an indication of at least one of: a quantity of downlink subbands, within the CC, that are supported by the UE, whether a single downlink subband or multiple downlink subbands within the CC are supported by the UE, a first supported quantity of frequency domain resources between subbands within the CC, a second supported quantity of frequency domain resources between subbands within the CC, a bandwidth of each subband associated with the CC, or a third supported quantity of frequency domain resources between an uplink subband and the downlink subband associated with the UE filtering out signals included in the uplink subband when receiving signals included in the downlink subband.

Aspect 23: The method of any of Aspects 19-22, wherein receiving the indication comprises receiving the indication on at least one of a feature set per CC (FSPC) basis, a feature set (FS) basis, or a frequency band basis.

Aspect 24: The method of any of Aspects 19-23, wherein the slot is a subband full-duplex (SBFD) slot associated with one or more downlink subbands and one or more uplink subbands.

Aspect 25: The method of any of Aspects 19-24, wherein the UE is associated with an in-channel selectivity (ICS) value that indicates a measure of an amount of interference rejection caused by a signal received in an adjacent subband, to a downlink subband associated with the downlink signal, within the CC that can be filtered out by the UE.

Aspect 26: The method of Aspect 25, wherein the ICS value is a ratio of a first filter attenuation associated with the downlink subband to a second filter attenuation associated with the adjacent subband.

Aspect 27: The method of any of Aspects 25-26, wherein the ICS value is a ratio of a received power associated with the signal received in the adjacent subband to a power of the signal after the UE performs the filtering associated with the downlink subband.

Aspect 28: The method of any of Aspects 25-27, further comprising receiving an indication of the ICS value.

Aspect 29: The method of any of Aspects 19-28, wherein the downlink signal is associated with a first transmission power, wherein a downlink subband associated with the downlink signal is associated with a first bandwidth, and the method further comprising: transmitting an interfering signal associated with another subband within the CC, wherein the interfering signal is associated with a second transmission power, wherein the other subband is associated with a second bandwidth, and wherein the downlink subband and the other subband are separated in a frequency domain by a quantity of frequency domain resources.

Aspect 30: The method of Aspect 29, wherein the second transmission power is greater than or equal to the first transmission power.

Aspect 31: The method of any of Aspects 29-30, wherein the first transmission power is based at least in part on a receiver sensitivity (REFSENSE) test value modified by a first value, wherein the first value is based at least in part on the ICS value.

Aspect 32: The method of Aspect 31, wherein the second transmission power is based at least in part on the REFSENSE test value modified by a second value, wherein the second value is based at least in part on the ICS value.

Aspect 33: The method of any of Aspects 31-32, wherein the REFSENSE test value is based at least in part on an operating configuration associated with the UE, wherein the operating configuration includes at least one of: a frequency range, a sub-frequency range, a non-terrestrial network configuration, a terrestrial network configuration, a licensed frequency band configuration, an unlicensed frequency band configuration, a sidelink configuration, an intra-band carrier aggregation configuration, an inter-band carrier aggregation configuration, a dual connectivity configuration, a transmit receive point (TRP) configuration, or a transmission configuration indicator (TCI) state configuration.

Aspect 34: The method of any of Aspects 29-33, wherein at least one of the second transmission power, the second bandwidth, or the quantity of frequency domain resources is based at least in part on the first bandwidth.

Aspect 35: The method of any of Aspects 29-34, further comprising receiving a measurement report indicating a measurement of the interfering signal performed by the UE.

Aspect 36: The method of any of Aspects 28-35, wherein the ICS value is based at least in part on an operating configuration associated with the UE, wherein the operating configuration includes at least one of: a frequency range, a sub-frequency range, a non-terrestrial network configuration, a terrestrial network configuration, a licensed frequency band configuration, an unlicensed frequency band configuration, a sidelink configuration, an intra-band carrier aggregation configuration, an inter-band carrier aggregation configuration, a dual connectivity configuration, a transmit receive point (TRP) configuration, or a transmission configuration indicator (TCI) state configuration.

Aspect 37: The method of any of Aspects 19-36, wherein the indication is based at least in part on a cross-link interference (CLI) measurement report.

Aspect 38: An apparatus for wireless communication at a device, comprising a processor; memory coupled with the processor; and instructions stored in the memory and executable by the processor to cause the apparatus to perform the method of one or more of Aspects 1-18.

Aspect 39: A device for wireless communication, comprising a memory and one or more processors coupled to the memory, the one or more processors configured to perform the method of one or more of Aspects 1-18.

Aspect 40: An apparatus for wireless communication, comprising at least one means for performing the method of one or more of Aspects 1-18.

Aspect 41: A non-transitory computer-readable medium storing code for wireless communication, the code comprising instructions executable by a processor to perform the method of one or more of Aspects 1-18.

Aspect 42: A non-transitory computer-readable medium storing a set of instructions for wireless communication, the set of instructions comprising one or more instructions that, when executed by one or more processors of a device, cause the device to perform the method of one or more of Aspects 1-18.

Aspect 43: An apparatus for wireless communication at a device, comprising a processor; memory coupled with the processor; and instructions stored in the memory and executable by the processor to cause the apparatus to perform the method of one or more of Aspects 19-37.

Aspect 44: A device for wireless communication, comprising a memory and one or more processors coupled to the memory, the one or more processors configured to perform the method of one or more of Aspects 19-37.

Aspect 45: An apparatus for wireless communication, comprising at least one means for performing the method of one or more of Aspects 19-37.

Aspect 46: A non-transitory computer-readable medium storing code for wireless communication, the code comprising instructions executable by a processor to perform the method of one or more of Aspects 19-37.

Aspect 47: A non-transitory computer-readable medium storing a set of instructions for wireless communication, the set of instructions comprising one or more instructions that, when executed by one or more processors of a device, cause the device to perform the method of one or more of Aspects 19-37.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A user equipment (UE) for wireless communication, comprising:
at least one memory; and
at least one processor communicatively coupled with the at least one memory, the at least one processor configured to cause the UE to:
transmit, to a network entity, an indication that the UE supports downlink subband filtering within a bandwidth of a component carrier (CC) associated with the UE; and
receive, from the network entity and based on transmitting the indication, a downlink signal within a downlink subband that is included in the bandwidth of the CC based on filtering out signals within the bandwidth of the CC that are associated with frequency domain resources not included within the downlink subband.

2. The UE of claim 1, wherein the indication that the UE supports downlink subband filtering within the bandwidth of the CC includes an indication of at least one of:
a quantity of downlink subbands, within the CC, that are supported by the UE,
whether a single downlink subband or multiple downlink subbands within the CC are supported by the UE,
a first supported quantity of frequency domain resources between subbands within the CC,
a second supported quantity of frequency domain resources between subbands within the CC,
a bandwidth of each subband associated with the CC, or
a third supported quantity of frequency domain resources between an uplink subband and the downlink subband associated with the UE filtering out signals included in the uplink subband when receiving signals included in the downlink subband.

3. The UE of claim 1, wherein the at least one processor is further configured to cause the UE to receive, from the network entity and based at least in part on transmitting the indication, a communication scheduling the downlink signal in a subband full-duplex (SBFD) slot associated with one or more downlink subbands including the downlink subband, and one or more uplink subbands.

4. The UE of claim 1, wherein the UE is associated with an in-channel selectivity (ICS) value that indicates a measure of an amount of interference rejection caused by a signal received in an adjacent subband, to the downlink subband, within the bandwidth of the CC that can be filtered out by the UE.

5. The UE of claim 4, wherein the ICS value is a ratio of a first filter attenuation associated with the downlink subband to a second filter attenuation associated with the adjacent subband.

6. The UE of claim 4, wherein the at least one processor is further configured to cause the UE to transmit, to the network entity, an indication of the ICS value.

7. The UE of claim 1, wherein the downlink signal is associated with a first transmission power, wherein the downlink subband is associated with a first bandwidth, and wherein, to cause the UE to receive the downlink signal, the at least one processor is configured to cause the UE to:
receive an interfering signal associated with another subband within the CC, wherein the interfering signal is associated with a second transmission power, wherein the other subband is associated with a second bandwidth, and wherein the downlink subband and the other subband are separated in a frequency domain by a quantity of frequency domain resources; and
filter the downlink signal to reduce interference caused by the interfering signal.

8. The UE of claim 7, wherein the first transmission power is based at least in part on a receiver sensitivity (REFSENSE) test value modified by a first value, wherein the first value is based at least in part on an in-channel selectivity (ICS) value.

9. The UE of claim 8, wherein the second transmission power is based at least in part on the REFSENSE test value modified by a second value, wherein the second value is based at least in part on the ICS value.

10. The UE of claim 8, wherein the REFSENSE test value is based at least in part on an operating configuration associated with the UE, wherein the operating configuration includes at least one of:
a frequency range,
a sub-frequency range,
a non-terrestrial network configuration,
a terrestrial network configuration,
a licensed frequency band configuration,
an unlicensed frequency band configuration,
a sidelink configuration,
an intra-band carrier aggregation configuration,
an inter-band carrier aggregation configuration,
a dual connectivity configuration,
a transmit receive point (TRP) configuration, or
a transmission configuration indicator (TCI) state configuration.

11. The UE of claim 7, wherein the at least one processor is further configured to cause the UE to transmit, to the network entity, a measurement report indicating a measurement of the interfering signal.

12. A network entity for wireless communication, comprising:
at least one memory; and
at least one processor communicatively coupled with the at least one memory, the at least one processor configured to cause the network entity to:
receive an indication that a user equipment (UE) supports downlink subband filtering within a bandwidth of a component carrier (CC) associated with the UE; and
transmit, based on receiving the indication, a communication scheduling a downlink signal for the UE associated with the CC in a slot associated with full-duplex operations.

13. The network entity of claim 12, wherein the at least one processor is further configured to cause the network entity to transmit the downlink signal intended for the UE.

14. The network entity of claim 12, wherein the UE is associated with an in-channel selectivity (ICS) value that indicates a measure of an amount of interference rejection caused by a signal received in an adjacent subband, to a downlink subband associated with the downlink signal, within the CC that can be filtered out by the UE.

15. The network entity of claim 14, wherein the ICS value is based at least in part on an operating configuration associated with the UE, wherein the operating configuration includes at least one of:
a frequency range,
a sub-frequency range,
a non-terrestrial network configuration,
a terrestrial network configuration,
a licensed frequency band configuration,
an unlicensed frequency band configuration,
a sidelink configuration,
an intra-band carrier aggregation configuration,
an inter-band carrier aggregation configuration,
a dual connectivity configuration,
a transmit receive point (TRP) configuration, or
a transmission configuration indicator (TCI) state configuration.

16. A method of wireless communication performed by a user equipment (UE), comprising:
transmitting, to a network entity, an indication that the UE supports downlink subband filtering within a bandwidth of a component carrier (CC) associated with the UE; and
receiving, from the network entity and based on transmitting the indication, a downlink signal within a downlink subband that is included in the bandwidth of the CC based on filtering out signals within the bandwidth of the CC that are associated with frequency domain resources not included within the downlink subband.

17. The method of claim 16, wherein the indication that the UE supports downlink subband filtering within the bandwidth of the CC includes an indication of at least one of:
a quantity of downlink subbands, within the CC, that are supported by the UE,
whether a single downlink subband or multiple downlink subbands within the CC are supported by the UE,
a first supported quantity of frequency domain resources between subbands within the CC,
a second supported quantity of frequency domain resources between subbands within the CC,
a bandwidth of each subband associated with the CC, or
a third supported quantity of frequency domain resources between an uplink subband and the downlink subband associated with the UE filtering out signals included in the uplink subband when receiving signals included in the downlink subband.

18. The method of claim 16, wherein transmitting the indication comprises transmitting the indication on at least one of a feature set per CC (FSPC) basis, a feature set (FS) basis, or a frequency band basis.

19. The method of claim 16, wherein the UE is associated with an in-channel selectivity (ICS) value that indicates a measure of an amount of interference rejection caused by a signal received in an adjacent subband, to the downlink subband, within the bandwidth of the CC that can be filtered out by the UE.

20. The method of claim 19, wherein the ICS value is a ratio of a received power associated with the signal received in the adjacent subband to a power of the signal after the UE performs the filtering associated with the downlink subband.

21. The method of claim 19, wherein the ICS value is based at least in part on an operating configuration associated with the UE, wherein the operating configuration includes at least one of:
a frequency range,
a sub-frequency range,
a non-terrestrial network configuration,
a terrestrial network configuration,
a licensed frequency band configuration,
an unlicensed frequency band configuration,
a sidelink configuration,
an intra-band carrier aggregation configuration,
an inter-band carrier aggregation configuration,
a dual connectivity configuration,
a transmit receive point (TRP) configuration, or
a transmission configuration indicator (TCI) state configuration.

22. The method of claim 16, wherein the downlink signal is associated with a first transmission power, wherein the downlink subband is associated with a first bandwidth, and wherein receiving the downlink signal comprises:
receiving an interfering signal associated with another subband within the CC, wherein the interfering signal is associated with a second transmission power, wherein the other subband is associated with a second bandwidth, and wherein the downlink subband and the other subband are separated in a frequency domain by a quantity of frequency domain resources; and
filtering the downlink signal to reduce interference caused by the interfering signal.

23. The method of claim 22, wherein the second transmission power is greater than or equal to the first transmission power.

24. The method of claim 22, wherein at least one of the second transmission power, the second bandwidth, or the quantity of frequency domain resources is based at least in part on the first bandwidth.

25. The method of claim 16, wherein the indication is based at least in part on a cross-link interference (CLI) measurement report.

26. A method of wireless communication performed by a network entity, comprising:
receiving an indication that a user equipment (UE) supports downlink subband filtering within a bandwidth of a component carrier (CC) associated with the UE; and
transmitting, based on receiving the indication, a communication scheduling a downlink signal for the UE associated with the CC in a slot associated with full-duplex operations.

27. The method of claim 26, further comprising transmitting the downlink signal intended for the UE.

28. The method of claim 26, wherein the indication that the UE supports downlink subband filtering within the bandwidth of the CC includes an indication of at least one of:
a quantity of downlink subbands, within the CC, that are supported by the UE,
whether a single downlink subband or multiple downlink subbands within the CC are supported by the UE,
a first supported quantity of frequency domain resources between subbands within the CC,
a second supported quantity of frequency domain resources between subbands within the CC,
a bandwidth of each subband associated with the CC, or
a third supported quantity of frequency domain resources between an uplink subband and the downlink subband associated with the UE filtering out signals included in the uplink subband when receiving signals included in the downlink subband.

29. The method of claim 26, wherein the slot is a subband full-duplex (SBFD) slot associated with one or more downlink subbands and one or more uplink subbands.

30. The method of claim 26, wherein the indication is based at least in part on a cross-link interference (CLI) measurement report.
